(19) United States
(12) Patent Application Publication
(10) Pub. No.: US 2025/0148582 A1
(43) Pub. Date: May 8, 2025

(54) ELECTRONIC DEVICE AND METHOD FOR VISUAL DISTORTION CORRECTION

(71) Applicant: Samsung Electronics Co., Ltd., Suwon-si (KR)

(72) Inventors: Hongjun KIM, Suwon-si (KR); Eungjoo LEE, Suwon-si (KR); Wooyoung JEONG, Suwon-si (KR)

(21) Appl. No.: 19/003,479

(22) Filed: Dec. 27, 2024

Related U.S. Application Data
(63) Continuation of application No. PCT/KR2023/008319, filed on Jun. 15, 2023.

(30) Foreign Application Priority Data
Aug. 3, 2022 (KR) 10-2022-0096876
Sep. 14, 2022 (KR) 10-2022-0115765

(51) Int. Cl. G06T 5/80; G06F 1/16; G06F 3/01

(52) U.S. Cl. CPC G06T 5/80; G06F 1/1652; G06F 1/1677; G06F 3/013

(57) ABSTRACT

An electronic device, according to an embodiment, may comprise: a first housing including a first side and a second side opposite to the first side. The electronic device may comprise a second housing including a third side and a fourth side opposite to the third side. The electronic device may comprise: at least one processor comprising processing circuitry; at least one camera; at least one distance sensor; and a flexible display. The electronic device may comprise a hinge structure configured to provide, by rotatably connecting the first housing and the second housing based on a folding axis, an unfolded state in which the first side and the third side face the same direction, a folded state in which the first side and the third side face each other, or an intermediate state in which the first side and the third side form an angle between the angle in the unfolded state and the angle in the folded state.

### CROSS-REFERENCE TO RELATED APPLICATIONS

This application is a continuation of International Application No. PCT/KR2023/008319 designating the United States, filed on Jun. 15, 2023, in the Korean Intellectual Property Receiving Office and claiming priority to Korean Patent Application Nos. 10-2022-0096876, filed on Aug. 3, 2022, and 10-2022-0115765, filed on Sep. 14, 2022, in the Korean Intellectual Property Office, the disclosures of each of which are incorporated by reference herein in their entireties.

### BACKGROUND

### Field

The disclosure relates to an electronic device and a method for visual distortion compensation according to a change of a state of a display in a flexible display.

### Description of Related Art

A state of an electronic device including a flexible display may be changed. According to a change of the state of the flexible display and a position of a user's gaze, a screen displayed on the flexible display may be visually distorted. A method compensating visual distortion of the screen will be described below.

The above-described information may be provided as a related art for the purpose of helping to understand the present disclosure. No claim or determination is raised as to whether any of the above description may be applied as a prior art related to the present disclosure.

### SUMMARY

According to an example embodiment, an electronic device may comprise: a first housing including a first side and a second side opposite the first side; a second housing including a third side and a fourth side opposite to the third side; at least one processor, comprising processing circuitry, at least one camera, at least one distance detection sensor, and a flexible display; by rotatably connecting the first housing and the second housing with respect to a folding axis, a hinge structure comprising a hinge configured to provide an unfolded state in which the first side and the third side face a same direction, a folded state in which the first side and the third side face each other, and/or an intermediate state in which the first side and the third side form an angle between an angle in the unfolded state and an angle in the folded state; a folding detection sensor configured to detect an angle between the first side and the third side of the flexible display, wherein at least one processor, individually and/or collectively, may be configured control the electronic device to: display a first image on a first display area of the flexible display in the unfolded state; obtain first coordinate information of the first display area of the flexible display corresponding to the unfolded state; based on detecting the intermediate state, obtain folding information corresponding to an angle between the first side and the third side of the flexible display; based on the at least one distance detection sensor and the at least one camera, obtain user gaze information; based on the user gaze information, the folding information, and the first coordinate information of the first display area, obtain second coordinate information of a second display area corresponding to the intermediate state; generate a second image based on the first image and the second coordinate information of the second display area; and display the second image in the second display area of the flexible display, in the intermediate state.

A method performed by an electronic device according to an example embodiment may include: displaying a first image on a first display area of a flexible display in an unfolded state; obtaining first coordinate information of the first display area of the flexible display corresponding to the unfolded state; based on detecting the intermediate state, obtaining folding information corresponding to an angle between a first side and a third side of the flexible display; based on at least one distance detection sensor and at least one camera, obtaining user gaze information; based on the user gaze information, the folding information, and the first coordinate information of the first display area, obtaining second coordinate information of a second display area corresponding to the intermediate state; generating a second image based on the first image and the second coordinate information of the second display area; and displaying the second image in the second display area of the flexible display, in the intermediate state.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a perspective view illustrating an example of an unfolded state of an electronic device according to various embodiments;

FIG. 3 is a perspective view illustrating an example of a folded state of an electronic device according to various embodiments;

FIG. 4 is a diagram illustrating an example of distortion compensation of a display according to according to various embodiments;

FIG. 5A is a diagram illustrating an example of distortion compensation performed based on a user's gaze facing a central axis of a display according to various embodiments;

FIG. 5B is a diagram illustrating an example of x-axis distortion compensation performed based on a user's gaze facing a central axis of a display according to various embodiments;

FIG. 5C is a diagram illustrating an example of y-axis distortion compensation performed based on a user's gaze facing a central axis of a display according to various embodiments;

FIG. 5D is a diagram illustrating an example of a distortion-compensated screen performed based on a user's gaze facing a central axis of a display according to various embodiments;

FIG. 6A is a diagram illustrating an example of distortion compensation performed based on a projection side where an angle formed by a first housing and a second housing is the same according to various embodiments;

FIG. 6B is a diagram illustrating an example of x-axis distortion compensation performed based on a projection side where an angle formed by a first housing and a second housing is the same according to various embodiments;

FIG. 6C is a diagram illustrating an example of a distortion-compensated screen performed based on a projection side where an angle formed by a first housing and a second housing is the same according to various embodiments;

FIG. 7A is a diagram illustrating an example of distortion compensation of an electronic device based on a projection side perpendicular to a user's gaze according to various embodiments;

FIG. 7B is a diagram illustrating an example of x-axis distortion compensation performed based on a projection side perpendicular to a user's gaze according to various embodiments;

FIG. 7C is a diagram illustrating an example of a distortion-compensated screen performed based on a projection side perpendicular to a user's gaze according to various embodiments;

FIG. 8 is a diagram illustrating an example of using a margin by distortion compensation for displaying information according to various embodiments;

FIG. 9 is a diagram illustrating an example of image loss capable of occurring during distortion compensation according to various embodiments;

FIG. 10 is a diagram illustrating an example of a notification for indicating image loss during distortion compensation according to various embodiments;

FIG. 11 is a diagram illustrating an example of image reduction during distortion compensation according to various embodiments;

FIG. 12 is a diagram illustrating an example of image enlargement during distortion compensation according to various embodiments;

FIG. 13 is a diagram illustrating an example of distortion compensation in which only a part of a display area is applied, according to various embodiments;

FIG. 14 is a diagram illustrating an example of selection of a display area where distortion compensation is to be applied, according to various embodiments;

FIG. 15 is a diagram illustrating an example of whether to change distortion compensation performed based on a change of a user's gaze, according to various embodiments; and

FIG. 16 is a flowchart illustrating an example operation of displaying a distortion compensation image based on user gaze information, folding information, and a first display area, according to various embodiments.

### DETAILED DESCRIPTION

Terms used in the present disclosure are used simply to describe a various example embodiments and are not be intended to limit a range of any embodiment. A singular expression may include a plural expression unless context clearly indicates otherwise. Terms used herein, including a technical or scientific term, may have the same meaning as those generally understood by those skilled in the art described in the present disclosure. Among the terms used in the present disclosure, terms defined in a general dictionary may be interpreted in the same or similar meaning as contextual meaning of related technology, and are not interpreted in an ideal or overly formal meaning unless explicitly defined in the present disclosure. In some cases, even terms defined in the present disclosure are not to be interpreted to exclude embodiments of the present disclosure.

In various embodiments of the present disclosure described below, a hardware approach will be described as an example. However, since the various embodiments of the present disclosure include a technology using both hardware and software, the various embodiments of the present disclosure do not exclude a software-based approach.

A term (e.g., distortion compensation, changing, and switching) referring to distortion compensation, a term (e.g., a first display area, a display area before distortion compensation, a display area displaying the first image, and a display area displaying image before distortion compensation) referring to the first display area, a term (e.g., a display area displaying after distortion compensation, a display area displaying the second image, and a display area displaying image after distortion compensation) referring to the second display area, a term (e.g., the first image, and an original image) referring to an image before distortion compression, a term (e.g., the second image, a compression image, a changing image, and a switching image) referring to an image after distortion compensation, and a term (e.g., a margin part, and a surplus part) referring to a margin part of display, which are used in the following description are used for convenience of explanation. Therefore, the present disclosure is not limited to terms described below, and another term having equivalent technical meaning may be used. In addition, a term ‘ . . . part’, ‘ . . . device’, ‘ . . . material’, and ‘ . . . structure’ used herein may refer at least one structural configuration or a unit that processes a function.

In addition, in the present disclosure, expressions of ‘greater than’ or ‘less than’ may be used to determine whether a particular condition is satisfied or fulfilled, but this is only a description for expressing an example and does not exclude a description of ‘greater than or equal to’ or ‘less than or equal to’. A condition written as ‘greater than or equal to’ may be replaced with ‘greater than’, a condition written as ‘less than or equal to’ may be replaced with ‘less than’, and a condition written as ‘greater than or equal to and less than’ may be replaced with ‘greater than and less than or equal to’. In addition, hereinafter, ‘A’ to ‘B’ refer to at least one of elements from A (including A) to B (including B). Hereinafter, ‘C’ and/or ‘D’ refer to including at least one of ‘C’ or ‘D’, that is, {‘C’, ‘D’, and ‘C’ and ‘D’}.

Prior to describing various example embodiments of the present disclosure, terms used to describe operations of an electronic device according to various embodiments are defined. A foldable electronic device may refer an electronic device including a hinge structure configured to provide a folded state, an unfolded state, and an intermediate state. The foldable electronic device may include a flexible display. The foldable electronic device may include a first housing including a first side and a second side opposite to the first side. The foldable electronic device may include a second housing including a third side and a fourth side. The unfolded state of the foldable electronic device may refer a structure of an electronic device that is fully unfolded so that the first side and the third side face a same direction. The folded state of the foldable electronic device may refer a structure of an electronic device that is folded so that the first side and the third side face each other. The intermediate state may refer a structure of an electronic device in which the first side and the third side are folded to form an angle between an angle in the unfolded state and an angle in the folded state. A first display area may refer a display area of a display in the unfolded state. The first display area may refer a display area of the display before distortion compensation by perspective. A second display area may refer a display area of the display after distortion compensation by perspective. First coordinate information may refer coordinates capable of specifying the first display area. For example, the first coordinate information may refer coordinates of a vertex of the first display area and coordinates of an end of a folding axis. Second coordinate information may refer coordinates capable of specifying the second display area. For example, the second coordinate information may refer coordinates of a vertex of the second display area and coordinates of an end of the folding axis. The folding axis may refer an axis where the first housing and the second housing are folded. A central axis may refer a side that is perpendicular to the flexible display in the unfolded state and includes the folding axis. User's gaze may refer a point corresponding to the user's pupils observing the display. According to an embodiment, the user's gaze may refer a point corresponding to a pupil of a side mainly used by the user. According to an embodiment, the user's gaze may refer a point corresponding to a pupil of the side designated by the user. According to an embodiment, the user's gaze may refer a point corresponding to a pupil close to the display. Since a degree of change in the display area for the distortion compensation increases when receding from the display, many margin parts may occur. According to an embodiment, the user's gaze may refer a point corresponding to a middle part of both pupils of the user. User gaze information may include a coordinate of the user gaze.

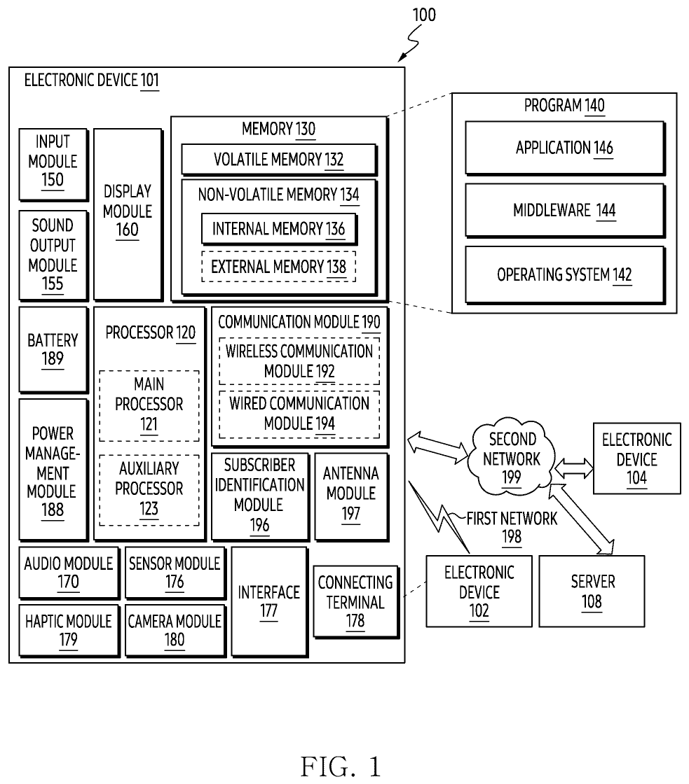

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

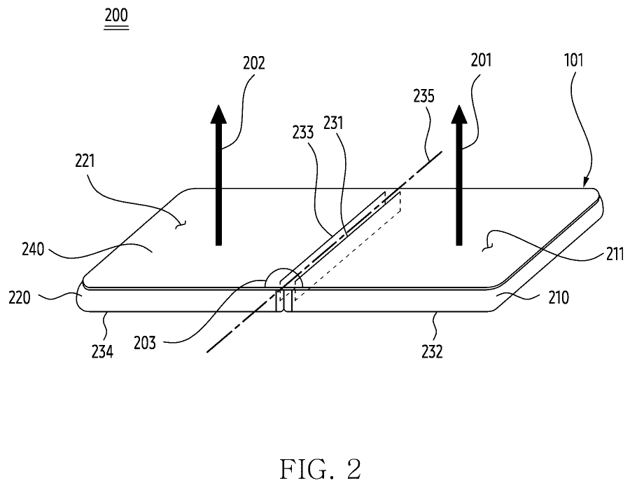

FIG. 2 is a perspective view an example of an unfolded state of an electronic device according to various embodiments.

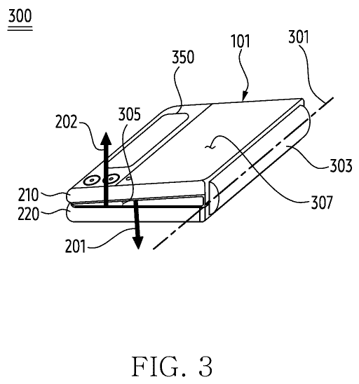

FIG. 3 is a perspective view illustrating an example of a folded state of an electronic device according to various embodiments.

According to an embodiment, a foldable electronic device (e.g., the electronic device 101 of FIG. 1) may provide various states. For example, an electronic device 101 may provide an unfolded state, an intermediate state, and a folded state.

Referring to FIG. 2, the electronic device 101 may be in a state 200, which is the unfolded state that a first housing 220 and a second housing 210 are fully folded out through a hinge structure (e.g., including a hinge) included in a folding housing (e.g., a folding housing 303 of FIG. 3).

According to an embodiment, the first housing 220 may include a first side 221, a second side (not shown) opposite to the first side 221, a first lateral side 233 and a second lateral side 234 between the first side 221 and the second side.

According to an embodiment, the second housing 210 may include a third side 211, a fourth side (e.g., a fourth side 307 of FIG. 3) opposite to the third side 211, a third lateral side 231 and a fourth lateral side 232 between the third side 211 and the fourth side.

According to an embodiment, the folding housing may include a hinge structure that rotatably connects the first lateral side 233 of the first housing 220 and the third lateral side 231 of the second housing 210 facing the first lateral side 233 with respect to a folding axis 235.

According to an embodiment, the state 200 may refer a state that a first direction 202 in which the first side 221 of the first housing 220 faces corresponds to a second direction 201 in which the third side 211 of the second housing 210 faces. For example, the first direction 202 in the state 200 may be substantially parallel to the second direction 201. For example, the first direction 202 in the state 200 may be the same as the second direction 201.

According to an embodiment, the first side 221 may form substantially a flat surface with the third side 211 in the state 200. For example, an angle 203 between the first side 221 and the third side 211 in the state 200 may be 180 degrees. For example, the state 200 may refer a state capable of providing an entire display area of a first display 240 on the flat surface substantially. According to an embodiment, in the state 200, the display area of the first display 240 may not include a curved surface. The unfolded state may be referred to as an outspread state or an outspreading state.

Referring to FIG. 3, an electronic device (e.g., the electronic device 101 of FIG. 1) may provide a state 300, which is a folded state that a first housing 220 and a second housing 210 are folded in through a hinge structure in a folding housing 303 303 with respect to a folding axis 301.

According to an embodiment, the folded state including the state 300 may refer a state that a first direction 202 in which a first side (e.g., the first side 221 of FIG. 2) (not shown in FIG. 3) faces is distinguished from a second direction 201 in which a third side (e.g., the third side 211 of FIG. 2) (not shown in FIG. 3) faces. For example, in the state 300, an angle between the first direction 202 and the second direction 201 may be substantially 180 degrees, and the first direction 202 and the second direction 201 may be distinguished from each other. For example, in the state 300, an angle 305 between a first side 221 and a third side 211 may be substantially 0 degrees. The folding state may be referred to as a folded state. For example, as the first side 221 and the third side 211 faces each other through the hinge structure in the folding housing 303, an electronic device 101 may provide the state 300 that a display area of a first display 240 corresponding to the third side 211 substantially completely overlaps on a display area of the first display area 240 corresponding to the first side 221. For example, the electronic device 101 may provide the state 300 that the first direction 202 is substantially opposite to the second direction 201. For another example, in the state 300, the display area of the first display 240 may be covered within a user's view viewing the electronic device 101. However, the disclosure is not limited thereto.

In an embodiment, the first display 240 may be bent by rotation provided through the hinge structure in the folding housing 303. For example, in the state 300, a part of the display area of the first display 240 may be bent. For example, the part of the display area of the first display 240 may be in a state curvedly bent, in order to prevent/reduce damage to the first display 240 in the folded state. However, the disclosure is not limited thereto.

For example, a processor 120 may identify the angle between the first direction 202 in which the first side 221 of the first housing 220 faces and the second direction 201 in which the third side 211 of the second housing 210 faces, through at least one of a hole sensor in the electronic device 101, a first sensor in the electronic device 101, a rotation sensor in the folding housing 303, and a stretch sensor in the electronic device 101.

In an embodiment, the second housing 210 may include a second display 350 on a fourth side 307 opposite the third side 211. For example, the second display 350 may be used to provide visual information in a folded state in which the display area of the first display 240 is not visible.

According to an embodiment, the electronic device 101 may include at least one antenna formed in at least a part of a second lateral side 234 of the first housing 220. The electronic device 101 may include at least one antenna formed in at least a part of a fourth lateral side 232 of the second housing 210. For example, the at least one antenna formed in the at least a part of the second lateral side 234 of the first housing 220 may include a first antenna. The at least one antenna formed in the at least a part of the fourth lateral side 232 of the second housing 210 may include a second antenna.

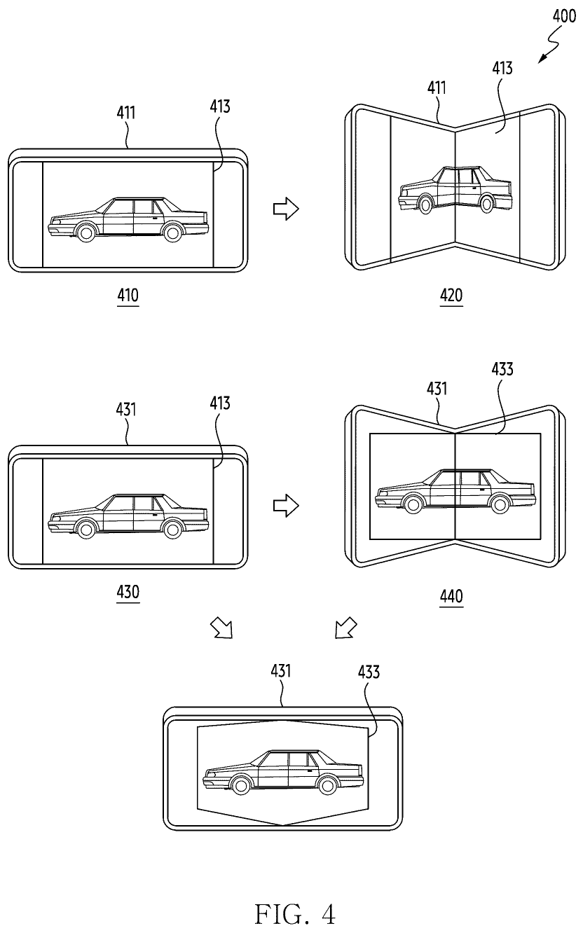

FIG. 4 is a diagram illustrating an example of distortion compensation of a display according to various embodiments. An electronic device (e.g., the electronic device 101) may perform the distortion compensation of a display (e.g., the display module 160) according to a state of the electronic device 101. The state of the electronic device 101 may be an unfolded state (e.g., the state 200), an intermediate state, or a folded state (e.g., the state 300). The display may be a flexible display.

Referring to FIG. 4, a state change diagram 400 illustrates a screen of foldable electronic devices 411 and 431 according to whether the distortion of the display is compensated. The foldable electronic device 411 and the foldable electronic device 431 illustrate the electronic device 101 of FIG. 1.

The foldable electronic device 411 may display an image before distortion compensation in an unfolded state 410. The foldable electronic device 411 may include a hinge structure for forming an unfolded state (e.g., the state 200 of FIG. 2), a folded state (e.g., the state 300 of FIG. 3), or an intermediate state. An image 413 before the distortion compensation in the unfolded state 410 may be displayed on a display of the foldable electronic device 411 in the unfolded state 410. Hereinafter, the image 413 before the distortion compensation may be referred to as a first image.

The foldable electronic device 411 may display the image before the distortion compensation in an intermediate state 420. A user viewing the foldable electronic device 411 from the front may see an image projected on a projection side. As the foldable electronic device 411 is folded, the image 413 before the distortion compensation may be visually distorted by perspective. Accordingly, the user viewing a scene of the foldable electronic device 411 may observe an image distorted by perspective. A scene part (e.g., both end parts of a vehicle) where a distance from the user's gaze is close, of the display may be seen relatively large. A scene part (e.g., a middle part of the vehicle) where a distance from the user's gaze is close, of the display may be seen relatively small.

The foldable electronic device 431 may perform a distortion compensation function. The foldable electronic device 431 may display the image 413 before the distortion compensation in an unfolded state 430. The foldable electronic device 431 may include a hinge structure for forming an unfolded state, a folded state, or an intermediate state. If a state of the foldable electronic device 431 is changed from the unfolded state to the intermediate state or the folded state, the distortion may occur in the image 413 before the distortion compensation as described above. Therefore, the foldable electronic device 431 may perform the distortion compensation. The foldable electronic device 431 may change the image 413 before the distortion compensation to an image 433 after the distortion compensation, through the distortion compensation. Hereinafter, the image 433 after the distortion compensation, which is an image after the distortion compensation, may be referred to as a second image.

The foldable electronic device 431 may display the image 433 after the distortion compensation in an intermediate state 440. The user viewing the foldable electronic device 431 may see an image projected on a projection side. As the foldable electronic device is folded, the image 433 after the distortion compensation may be visually distorted compared to the image 413 before the distortion compensation by perspective. However, since the foldable electronic device 431 distorts the image 413 before the distortion compensation in advance, the image 433 after the distortion compensation displayed in the intermediate state 440 may not be distorted from the user's point of view. For example, the foldable electronic device 431 may provide a relatively less distorted or not distorted image to the user through prior distortion. The user may observe the same view as a view with respect to the image 413 before the distortion compensation of the unfolded state 430 from the image 433 after the distortion compensation.

Hereinafter, distortion compensation methods in which the foldable electronic device 101 changes the image 413 (e.g., the first image) before the distortion compensation into the image 433 (e.g., the second image) after the distortion compensation will be described. The image 433 after the distortion compensation may be generated based on folding information corresponding to an angle formed between a first side of a first housing and a third side of a second housing of the foldable electronic device 101. The folding information may be a folding angle, which is an angle formed by the first side and the third side. The at least one processor 120 may obtain the folding information through a folding angle recognition sensor. The folding angle recognition sensor may be a plurality of 6-axis sensors or strain sensors. The plurality of 6-axis sensors may be sensors detecting a slope. The plurality of 6-axis sensors may be disposed on a printed circuit board (PCB) in an area of the first housing and the second housing, respectively. The folding information of the foldable electronic device 101 may be obtained based on a difference in slope measured by the plurality of 6-axis sensors. The strain sensor may be connected through a flexible printed circuit board (FPCB). When the foldable electronic device 101 is folded, the flexible printed circuit board (FPCB) may be bent. The foldable electronic device 101 may obtain an angle where the flexible printed circuit board (FPCB) is bent through the strain sensor. Therefore, the at least one processor may obtain the folding information through the strain sensor.

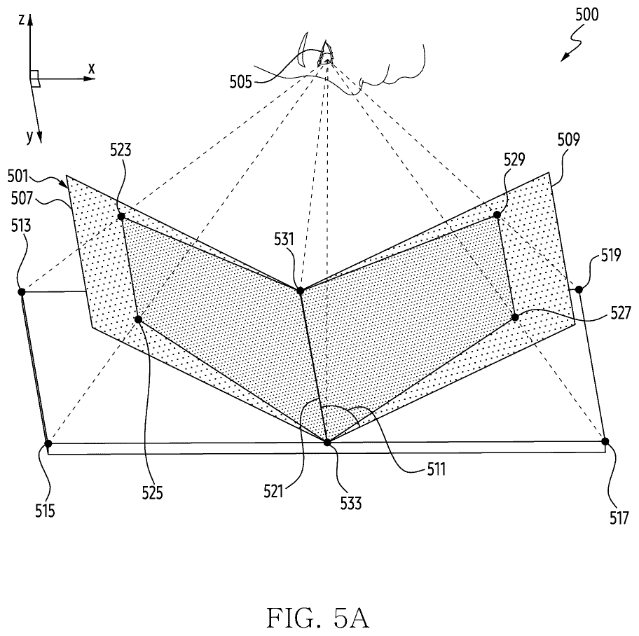

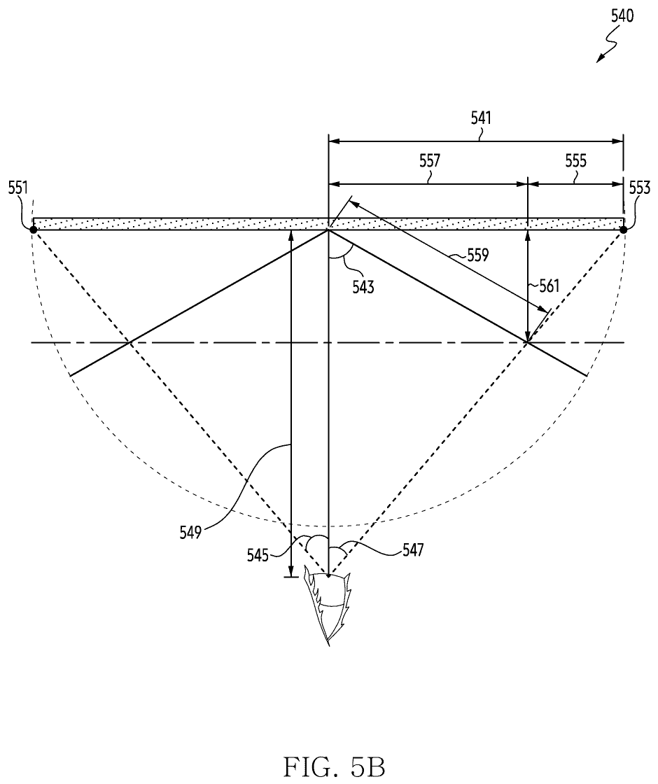

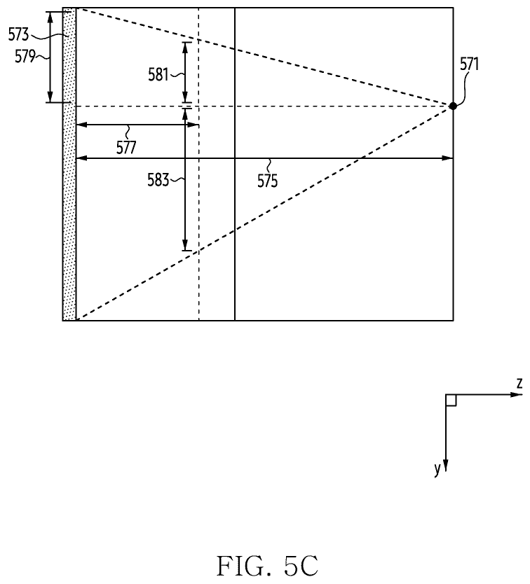

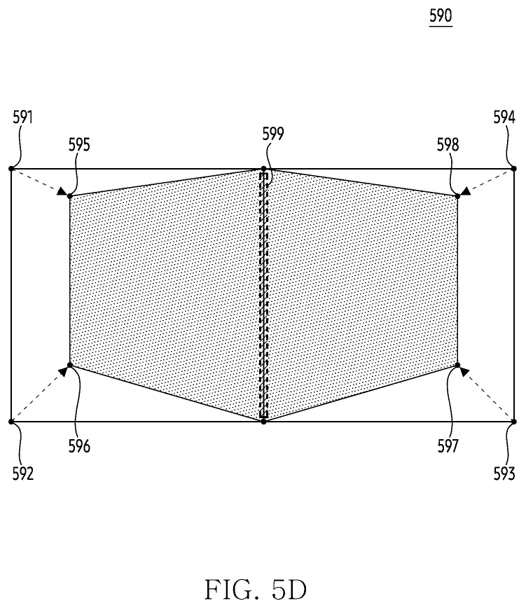

FIG. 5A is a diagram illustrating an example of distortion compensation performed based on a user's gaze facing a central axis of a display according to various embodiments. An electronic device (e.g., the electronic device 101) may perform distortion compensation of a display (e.g., the display module 160) in a state (e.g., the intermediate state) of the electronic device. Hereinafter, the display may be a flexible display. A distortion compensation method performed based on the user's gaze of which a position is on a central axis of the display may be referred to as a first distortion compensation method 500.

Referring to FIG. 5A, a foldable electronic device 501 (e.g., the electronic device 101 of FIG. 1) may perform a first distortion compensation method 500. A principle of the distortion compensation performed based on the user's gaze facing the central axis of the display of the foldable electronic device 501 will be illustrated, through the first distortion compensation method 500.

The foldable electronic device 501 (e.g., the foldable electronic device 431) in the intermediate state (e.g., the intermediate state 440) may be folded so that a first side of a first housing 507 and a third side of a second housing 509 form an angle between an angle (e.g., 180 degrees) in an unfolded state and an angle (e.g., 0 degree) in a folded state. A folding axis 521 may be an axis where the foldable electronic device 501 is folded. A position of a user's gaze 505 may be on the central axis of the display included in the foldable electronic device 501. The central axis may be a side that is perpendicular to the display in the unfolded state and includes the folding axis 521.

The foldable electronic device 501 may display a first display area in the unfolded state. The first display area may be specified by first coordinate information. The first coordinate information may include end coordinates of the first display area. The first coordinate information may include a coordinate 513, a coordinate 515, a coordinate 517, and a coordinate 519. The first coordinate information may include end coordinates of the folding axis. The first coordinate information may include a coordinate 531 and a coordinate 533. The foldable electronic device 501 may display a second display area in the intermediate state. The second display area may be specified by second coordinate information. The second coordinate information may include end coordinates of the second display area. The second coordinate information may include a coordinate 523, a coordinate 525, a coordinate 527, and a coordinate 529. The second coordinate information may include the end coordinates of the folding axis. The second coordinate information may include the coordinate 531 and the coordinate 533. The first coordinate information and the second coordinate information may share coordinates (e.g., the coordinate 531 and the coordinate 533) of the folding axis.

In the foldable electronic device 501 (e.g., the foldable electronic device 431) in the unfolded state (e.g., the unfolded state 430), the first side of the first housing 507 and the third side of the second housing 509 may face the same direction. An angle 511 may be a value formed by the first housing and a side that is perpendicular to the display in the unfolded state and includes the folding axis. The angle 511 may be a value formed by the second housing and a side that is perpendicular to the display in the unfolded state and includes the folding axis.

In order to compensated visual distortion by perspective occurring from the user's gaze 505, an image may be displayed on the second display area inside the second coordinate information. The user's gaze 505 may be a point corresponding to the user's pupils observing the display. According to an embodiment, the user's gaze 505 may be a point corresponding to a pupil of a side mainly used by the user. For example, the user's gaze 505 may indicate a point corresponding to a pupil of the left eye. For another example, the user's gaze 505 may indicate a point corresponding to a pupil of the right eye. According to an embodiment, the user's gaze 505 may be a point corresponding to a pupil of a side designated by the user. According to an embodiment, the user's gaze 505 may be a point corresponding to a pupil of a side close to the display. Since a degree of change in the display area for the distortion compensation increases when receding from the display, many margin parts may occur. According to an embodiment, the user's gaze 505 may be a point corresponding to between both pupils (e.g., center) of the user.

According to an embodiment, a processor 120 of the electronic device 101 may obtain the second coordinate information, based on the user's gaze 505 and the first coordinate information of the first display area. The user's gaze 505 may face a vertex of the first display area. A coordinate of a point where a line connecting the user's gaze 505 and a vertex (the coordinate 513, the coordinate 515, the coordinate 517, and the coordinate 519) of the first display area meets the flexible display of the foldable electronic device 501 may be determined as a coordinate of the second display area. For example, the foldable electronic device 501 may identify the coordinate 523 of a point where a line connecting the user's gaze 505 and the coordinate 513 meets the first side. The foldable electronic device 501 may identify the coordinate 525 of a point where a line connecting the user's gaze 505 and the coordinates 515 meets the first side. The foldable electronic device 501 may identify the coordinate 527 of a point where a line connecting the user's gaze 505 and the coordinate 517 meets the third side. The foldable electronic device 501 may identify the coordinate 529 of a point where a line connecting the user's gaze 505 and the coordinate 519 meets the third side.

The second coordinate information may be coordinates of points where a side connecting the vertices of the first display area of the foldable electronic device 501 in the unfolded state and the user's gaze meet the first side and the third side of the foldable electronic device 501 in the intermediate state.

User gaze information may include a coordinate of the user's gaze 505. According to an embodiment, the user gaze information may be obtained through a camera and a distance detection sensor. The user gaze information may identify a position (e.g., x-axis and y-axis coordinates) of the user's gaze through the camera, and identify a distance (e.g., z-axis coordinate) to the user's gaze through the distance detection sensor. The distance detection sensor may be a time of flight (TOF). The distance detection sensor may be light detection and ranging (Lidar).

FIG. 5B is a diagram illustrating an example 540 of x-axis distortion compensation performed based on a user's gaze facing a central axis of a display, according to various embodiments. FIG. 5B may be a result of the user viewing a first distortion compensation method 500 in a y-axis direction.

Referring to FIG. 5B, a first value 541 (e.g., x) may correspond to a length from a folding axis to ends 551 and 553 of the first display area. The first value 541 may be a given value. A second value 543 (e.g., a) may correspond to a first angle formed by the first housing and a side that is perpendicular to the display in the unfolded state and includes the folding axis. The second value 543 may be obtained based on a folding detection sensor. A third value 545 (e.g., b) may correspond to an angle formed by a direction that is perpendicular to the display in the unfolded state and includes the folding axis, and a direction in which the user's gaze faces the end 551 of the first display area within the first housing in the unfolded state. The third value 545 may be obtained based on the first value and a fifth value. A fourth value 547 (e.g., b) may correspond to an angle formed by a direction that is perpendicular to the flexible display in the unfolded state and includes the folding axis, and a direction in which the user's gaze faces the end 553 of the first display area within the second housing in the unfolded state. The fourth value 547 may be obtained through at least one camera and at least one distance detection sensor. A fifth value 549 (e.g., z) may refer a vertical distance between the user's gaze and the display in the unfolded state. The fifth value 549 may be obtained through the camera and the distance detection sensor.

A x1 value 555 may be a distance between a point where an end point of the second display area within the second housing in the intermediate state is projected and an end of the first display area in the unfolded state. A x2 value 557 may be a distance between the point where the end point of the second display area within the second housing in the intermediate state is projected and a point where the folding axis of the foldable electronic device is projected. A x3 value 559 may be a distance between the folding axis of the foldable electronic device and the end of the second display area within the second housing in the intermediate state. A x4 value 561 may be a vertical distance between the end point of the second display area within the second housing in the intermediate state and a projection side. By the trigonometric function, the following equations may be derived.

$$\frac{x 4}{x 1} = tan ( 90 - b ) \qquad [ Equation 1 ]$$

$$\frac{x 4}{x 2} = tan ( 90 - a ) \qquad [ Equation 2 ]$$

$$x 1 tan ( 90 - b ) = x 2 tan ( 90 - a ) \qquad [ Equation 3 ]$$

$$x = x 1 + x 2 \qquad [ Equation 4 ]$$

$$b = {tan}^{- 1} ( \frac{x}{z} ) \qquad [ Equation 5 ]$$

$$x 3 = \frac{x 2}{cos ( 90 - a )} \qquad [ Equation 6 ]$$

The x1 value 555, the x2 value 557, the x3 value 559, and the x4 value 561 may be obtained by simultaneously solving the equations. The x3 value 559 may be a distance between the end of the second display area of the second housing and the folding axis of the foldable electronic device in the intermediate state. In other words, the x3 value 559 may be an x-axis coordinate of the second display area of the second housing in the intermediate state. The x3 value may be derived as in Equation 7. The x4 value may be derived as in Equation 8.

$$x 3 = \frac{x}{\{ 1 + \frac{tan ( 90 - a )}{tan ( 90 - b )} \} * cos ( 90 - a )} \qquad [ Equation 7 ]$$

$$x 4 = \frac{x * tan ( 90 - a )}{\{ 1 + \frac{tan ( 90 - a )}{tan ( 90 - b )} \}} \qquad [ Equation 8 ]$$

When the folding axis is the y-axis, an x-axis distortion compensation coordinate may be the x3 value. The x4 value may be used when calculating a y-axis distortion compensation coordinate.

FIG. 5C is a diagram illustrating an example of y-axis distortion compensation performed based on a user's gaze facing a central axis of a display according to various embodiments. FIG. 5C illustrates the first distortion compensation method 500 viewed by the user from an x-axis direction.

Referring to FIG. 5C, a coordinate 571 of the user's gaze may be determined by a position of the user's gaze facing the display. A projection side 573 may be a side where a screen of the foldable electronic device in the intermediate state (e.g., the intermediate state 440) is projected. The projection side may be a side formed by the foldable electronic device in the unfolded state (e.g., the foldable electronic device 501 in the unfolded state of FIG. 5A).

A first value 575 (e.g., z) may be a vertical distance between the user's gaze and the display in the unfolded state. The first value 575 (e.g., the fifth value 549 of FIG. 5B) may be obtained through the camera and the distance detection sensor. A second value 577 (e.g., the x4 value 561 of FIG. 5B) (e.g., x4) may be a vertical distance between an end point of the second display area within the second housing in the intermediate state and the projection side. A third value 579 (e.g., y1) may be a distance between an end of the projection side in a folding axis direction and a point where the user's gaze is projected. The third value 579 may be obtained through the camera and the distance detection sensor. A y2 value 581 may be a distance from an end of the folding axis direction of the second display area of the foldable electronic device in the intermediate state to the point where the user's gaze is projected. A y3 value 583 may be a distance from another end of the folding axis direction of the second display area of the foldable electronic device in the intermediate state to the point where the user's gaze is projected. By the proportional equation, the following equations may be derived.

$$y 2 = \frac{( z - x 4 ) * y 1}{z} \qquad [ Equation 9 ]$$

$$y 3 = \frac{( y - y 1 ) * ( z - x 4 )}{z} \qquad [ Equation 10 ]$$

The y2 value 581 and the y3 value 583 may be obtained by the Equation 9 and the Equation 10. The y2 value 581 may be a y-axis coordinate of a vertex of the second display area in the intermediate state. The y3 value 583 may be a y-axis coordinate of another vertex of the second display area in the intermediate state.

Therefore, the foldable electronic device 101 may obtain a range of the second display area after distortion compensation using FIGS. 5B and 5C.

FIG. 5D is a diagram illustrating an example of a distortion-compensated screen performed based on a user's gaze facing a central axis of a display according to various embodiments.

Referring to FIG. 5D, a display area change diagram 590 may illustrate a first display area and a second display area before and after distortion compensation. The first display area may be a display area of the foldable electronic device before the distortion compensation. The second display area may be a display area of the foldable electronic device after the distortion compensation. Coordinates (a coordinate 591, a coordinate 592, a coordinate 593, and a coordinate 594) of vertices of the first display area and coordinates of an end of a folding axis 599 may be included in first coordinate information of the first display area before the distortion compensation. In an intermediate state, vertices of the display area may be changed from the coordinates (the coordinate 591, the coordinate 592, the coordinate 593, and the coordinate 594) of the vertices of the first display area to coordinates (a coordinate 595, a coordinate 596, a coordinate 597, and a coordinate 598) of vertices of the second display area, based on the first distortion compensation method. The coordinates (the coordinate 595, the coordinate 596, the coordinate 597, and the coordinate 598) of the vertices of the second display area and the coordinates of the end of the folding axis 599 may be included in second coordinate information of the second display area after the distortion compensation.

Since the position of the user's gaze on the central axis, the second display area may be left-right symmetrical.

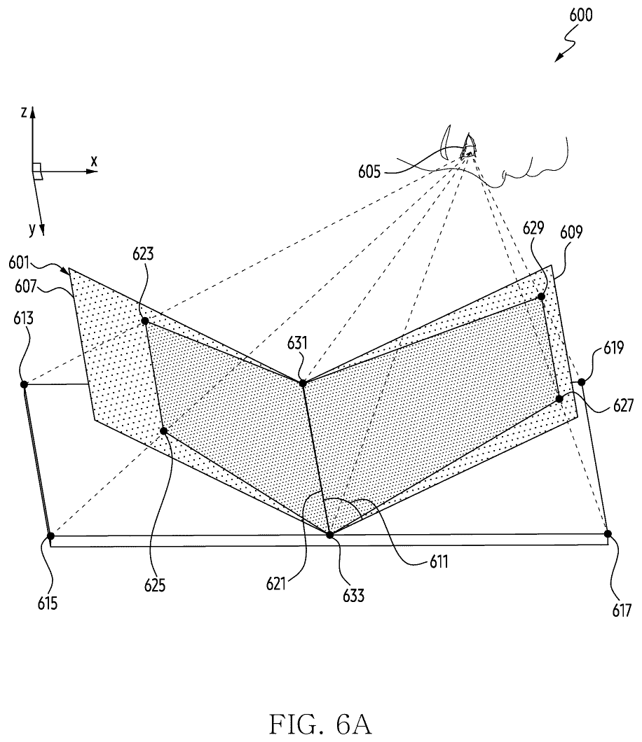

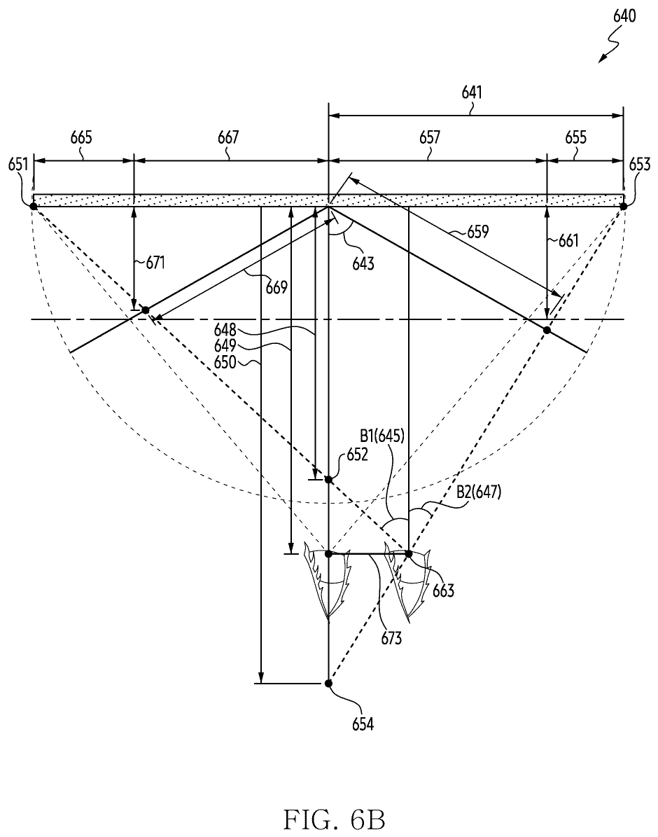

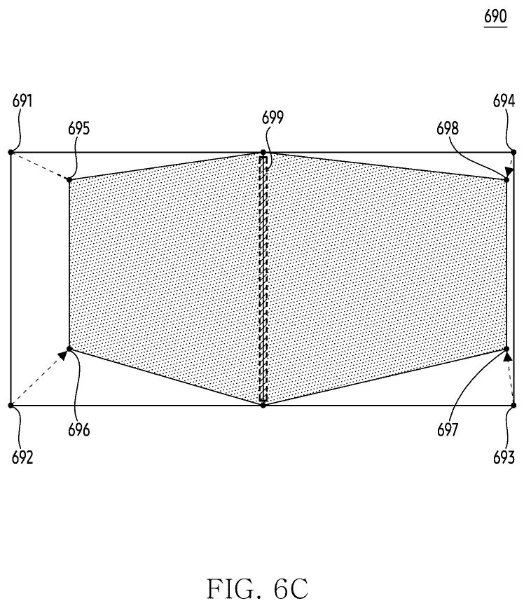

FIG. 6A is a diagram illustrating an example of distortion compensation performed based on a projection side having the same angle between a first housing and a second housing according to various embodiments. An electronic device (e.g., the electronic device 101) may perform distortion compensation of a display (e.g., the display module 160) in a state (e.g., an intermediate state) of the electronic device. In FIG. 6A, a position of the user's gaze may not be on a central axis, but face an arbitrary position. Hereinafter, the display may be a flexible display. A distortion compensation method performed based on the user's gaze facing the arbitrary position may be referred to as a second distortion compensation method 600.

Referring to FIG. 6A, a foldable electronic device 601 (e.g., the electronic device 101 of FIG. 1) may perform the second distortion compensation method 600. Thought the second distortion compensation method 600, a principle of the distortion compensation of the foldable electronic device 601 performed based on the projection side having the same angle between the first housing and the second housing will be illustrated.

The foldable electronic device 601 (e.g., the foldable electronic device 431) in an intermediate state (e.g., the intermediate state 440) may be folded so that a first side of a first housing 607 and a third side of a second housing 609 form an angle between an angle (e.g., 180 degrees) in an unfolded state and an angle (e.g., 0 degree) in a folded state. A folding axis 621 may refer an axis where the foldable electronic device 601 is folded. A user's gaze 605 may face an arbitrary position.

The foldable electronic device 601 may display a first display area in the unfolded state. The first display area may be specified by first coordinate information. The first coordinate information may include end coordinates of the first display area. The first coordinate information may include a coordinate 613, a coordinate 615, a coordinate 617, and a coordinate 619. The first coordinate information may include end coordinates of the folding axis. The first coordinate information may include a coordinate 631 and a coordinate 633. The foldable electronic device 601 may display a second display area in the intermediate state. The second display area may be specified by second coordinate information. The second coordinate information may include end coordinates of the second display area. The second coordinate information may include a coordinate 623, a coordinate 625, a coordinate 627, and a coordinate 629. The second coordinate information may include the end coordinates of the folding axis. The second coordinate information may include the coordinate 631 and the coordinate 633. The first coordinate information and the second coordinate information may share the coordinates (e.g., the coordinate 631 and the coordinate 633) of the folding axis.

In the foldable electronic device 601 (e.g., the foldable electronic device 431) of the unfolded state (e.g., the unfolded state 410 and the unfolded state 430 of FIG. 4), the first side of the first housing 607 and the third side of the second housing 609 may face the same direction. An angle a 611 may be a value formed by the first housing and a side that is perpendicular to the display and includes the folding axis in the unfolded state. The angle a 611 may be a value formed by the second housing and a side that is perpendicular to the display and includes the folding axis in the unfolded state.

In order to compensate for visual distortion caused by perspective from the user's gaze 605, an image may be displayed on the second display area inside the second coordinate information. The user's gaze 605 may be a point corresponding to the user's pupils observing the display. According to an embodiment, the user's gaze 605 may be a point corresponding to a pupil of a side mainly used by the user. For example, the user's gaze 605 may indicate a point corresponding to a pupil of the left eye. For another example, the user's gaze 605 may indicate a point corresponding to a pupil of the right eye. According to an embodiment, the user's gaze 605 may be a point corresponding to a pupil of a side designated by the user. According to an embodiment, the user's gaze 605 may be a point corresponding to a pupil of an eye close to the display. As a distance from the display increases, a degree of change in the display area for the distortion compensation increases, and many margin parts may occur. According to an embodiment, the user's gaze 605 may be a point corresponding to between both pupils (e.g., the center) of the user.

According to an embodiment, a processor 120 of the electronic device 101 may obtain the second coordinate information, based on the user's gaze 605 and the first coordinate information of the first display area. The user's gaze 605 may face a vertex of the first display area. A coordinate of a point where a line connecting the user's gaze 605 and the vertex of the first display area meets the flexible display of the foldable electronic device 601 may be determined as a coordinate of the second display area. For example, the foldable electronic device 601 may identify the coordinate 623 of a point where a line connecting the user's gaze 605 and the coordinate 613 meets the first side. The foldable electronic device 601 may identify the coordinate 625 of a point where a line connecting the user's gaze 605 and the coordinate 615 meets the first side. The foldable electronic device 601 may identify the coordinate 627 of a point where a line connecting the user's gaze 605 and the coordinate 617 meets the third side. The foldable electronic device 601 may identify the coordinate 629 of a point where a line connecting the user's gaze 605 and the coordinate 619 meets the third side.

The second coordinate information may be coordinates of points where a line connecting vertices (the coordinate 613, the coordinate 615, the coordinate 617, and the coordinate 619) of the first display area of the foldable electronic device 601 in the unfolded state, and the user's gaze 605 meets the first side and the third side of the foldable electronic device 601 in the intermediate state.

User gaze information may include a coordinate of the user's gaze. According to an embodiment, the user gaze information may be obtained through a camera and a distance detection sensor. The user gaze information may identify a position (e.g., x-axis and y-axis coordinates) of the user's gaze through the camera, and identify a distance (e.g., z-axis coordinate) to the user's gaze through the distance detection sensor. The distance detection sensor may be a time of flight (TOF). The distance detection sensor may be light detection and ranging (Lidar).

FIG. 6B is a diagram 640 illustrating an example of x-axis distortion compensation performed based on a projection side where an angle formed by a first housing and a second housing is the same according to various embodiments. It may be that the user is viewing the second distortion compensation method 600 from a y-axis direction.

Referring to FIG. 6B, a first value 641 (e.g., x) may correspond to a length from the folding axis to ends 651 and 653 of the first display area. The first value 641 may be a given value. A second value 643 (e.g., a) may correspond to a first angle formed by the second housing and a side that is perpendicular to the display in the unfolded state and includes the folding axis. The second value 643 may be obtained based on a folding detection sensor. A third value 645 (e.g., B1) may correspond to an angle formed by a direction that is perpendicular to the display in the unfolded state and includes the folding axis, and a direction in which the user's gaze faces the end 651 of the first display area within the first housing in the unfolded state. The third value 645 may be obtained based on the first value 641, a fifth value 649, and a x5 value 673. A fourth value 647 (e.g., B2) may correspond to an angle formed by a direction that is perpendicular to the flexible display in the unfolded state and includes the folding axis, and a direction in which the user's gaze faces the end 653 of the first display area within the second housing in the unfolded state. The fifth value 649 (e.g., z) may be a vertical distance between the user's gaze and the display in the unfolded state. The fifth value 649 may be obtained through the camera and the distance detection sensor. A sixth value 648 may be a vertical distance between a first virtual user gaze for obtaining second coordinate information of the first housing and the display in the unfolded state. A seventh value 650 may be a vertical distance between a second virtual user gaze for obtaining second coordinate information of the second housing and the display in the unfolded state.

Hereinafter, an x-axis coordinate of the distortion-compensated second display area within the first housing are derived. A x1 value 665 may be a distance between a point where an end point of the second display area within the first housing in the intermediate state is projected and an end of the first display area in the unfolded state. A x2 value 667 may be a distance between a point where the end point of the second display area within the second housing in the intermediate state is projected and a point where the folding axis of the foldable electronic device is projected. A x3 value 669 may be a distance between the folding axis of the foldable electronic device and the end of the second display area within the second housing in the intermediate state. A x4 value 671 may be a vertical distance between the end point of the second display area within the second housing in the intermediate state and a projection side. By the trigonometric function, the following equations may be derived. A z′ value 648 may refer a vertical distance between a first virtual user gaze 652 and the display in the unfolded state. The x5 value 673 may refer a distance between the user's gaze and a central axis of the display.

$$\frac{x 4}{x 1} = tan ( 90 - b 1 ) \qquad [ Equation 1 ]$$

$$\frac{x 4}{x 2} = tan ( 90 - a ) \qquad [ Equation 2 ]$$

$$x 1 tan ( 90 - b 1 ) = x 2 tan ( 90 - a ) \qquad [ Equation 3 ]$$

$$x = x 1 + x 2 \qquad [ Equation 4 ]$$

$$b 1 = {tan}^{- 1} ( \frac{x}{{z}^{′}} ) \qquad [ Equation 5 ]$$

$$x 3 = \frac{x 2}{cos ( 90 - a )} \qquad [ Equation 6 ]$$

$${z}^{′} = \frac{z * x}{x - x 5} \qquad [ Equation 11 ]$$

The x1 value 665, the x2 value 667, the x3 value 669, the x4 value 671, the x5 value 673, and the b1 value 645 may be obtained by solving the equations together as a system of the equations. The x3 value 669 may be a distance between the end of the second display area of the second housing and the folding axis of the foldable electronic device in the intermediate state. In other words, the x3 value 669 may be an absolute value of the x-axis coordinate of the second display area of the second housing in the intermediate state. The x3 value may be derived as in Equation 7. The x4 value may be derived as in Equation 8.

$$x 3 = \frac{x}{\{ 1 + \frac{tan ( 90 - a )}{tan ( 90 - b 1 )} \} * cos ( 90 - a )} \qquad [ Equation 7 ]$$

$$x 4 = \frac{x * tan ( 90 - a )}{\{ 1 + \frac{tan ( 90 - a )}{tan ( 90 - b 1 )} \}} \qquad [ Equation 8 ]$$

When the folding axis is the y axis, an x-axis distortion compensation coordinate may be a −x3 value. The x4 value may be used when calculating a y-axis distortion compensation coordinate. However, in case that the x5 value is the x value, in the Equation 11, the z′ value can not be obtained. Therefore, the −x3 value, which is the x-axis distortion compensation coordinate, may not be obtained. Thus, in case that the x5 value is the x value, at least one processor may obtain a distortion compensation coordinate by substituting an adjacent value instead of the x value to the x5 value.

The y-axis coordinates of the distortion-compensated second display area in the first housing and the second housing may be derived in the same manner as a y-axis distortion compensation method (e.g., FIG. 5C) performed based on the user's gaze facing the folding axis.

The virtual user gaze may be a virtual gaze on the central axis of the foldable electronic device assumed to induce the second distortion compensation method 600 from a first distortion compensation method 500. A coordinate after distortion compensation of the first housing may be the same as a coordinate after distortion compensation in case that the user's gaze is at a position of the first virtual user gaze 652. Accordingly, second coordinate information of the second display area of the first housing may be obtained by changing the fifth value (e.g., z) in the first distortion compensation method 500. A coordinate after distortion compensation of the second housing may be the same as the coordinate after distortion compensation in case that the user's gaze is at a position of a second virtual user gaze 654. Accordingly, second coordinate information of the second display area of the second housing may be obtained by changing the z value in the first distortion compensation method 500.

Hereinafter, an x-axis coordinate of the distortion-compensated second display area in the second housing will be derived. A x1 value 655 may be a distance between a point where an end point of the second display area within the first housing in the intermediate state is projected and an end of the first display area in the unfolded state. A x2 value 657 may be a distance between the point where the end point of the second display area within the second housing in the intermediate state is projected and a point where the folding axis of the foldable electronic device is projected. A x3 value 659 may be a distance between the folding axis of the foldable electronic device and the end of the second display area within the second housing in the intermediate state. A x4 value 661 may be a vertical distance between the end point of the second display area within the second housing in the intermediate state and a projection side. By the trigonometric function, the following equations may be derived. A z′ value 650 may refer a vertical distance between the second virtual user gaze 654 and the display in the unfolded state. A x5 value 663 may refer a distance between the user's gaze and the central axis of the display.

$$\frac{x 4}{x 1} = tan ( 90 - b 2 ) \qquad [ Equation 1 ]$$

$$\frac{x 4}{x 2} = tan ( 90 - a ) \qquad [ Equation 2 ]$$

$$x 1 tan ( 90 - b 2 ) = x 2 tan ( 90 - a ) \qquad [ Equation 3 ]$$

$$x = x 1 + x 2 \qquad [ Equation 4 ]$$

$$b 2 = {tan}^{- 1} ( \frac{x}{{z}^{′}} ) \qquad [ Equation 5 ]$$

$$x 3 = \frac{x 2}{cos ( 90 - a )} \qquad [ Equation 6 ]$$

$${z}^{′} = \frac{z * x}{x + x 5} \qquad [ Equation 12 ]$$

The x1 value 655, the x2 value 657, the x3 value 659, the x4 value 661, the x5 value 663, and the b2 value 647 may be obtained by solving the equations together as a system of the equations. The x3 value 659 may be a distance between the end of the second display area of the second housing and the folding axis of the foldable electronic device in the intermediate state. In other words, the x3 value 659 may be the x-axis coordinate of the second display area of the second housing in the intermediate state. The x3 value may be derived as in Equation 7. The x4 value may be derived as in Equation 8.

$$x 3 = \frac{x}{\{ 1 + \frac{tan ( 90 - a )}{tan ( 90 - b 2 )} \} * cos ( 90 - a )} \qquad [ Equation 7 ]$$

$$x 4 = \frac{x * tan ( 90 - a )}{\{ 1 + \frac{tan ( 90 - a )}{tan ( 90 - b 2 )} \}} \qquad [ Equation 8 ]$$

When the folding axis is the y axis, an x-axis distortion compensation coordinate may be the x3 value. The x4 value may be used when calculating a y-axis distortion compensation coordinate. However, in case that the x5 value is the −x value, in the Equation 12, the z′ value may not be obtained. Therefore, the x3 value, which is the x-axis distortion compensation coordinate, may also not be obtained. Thus, in case that the x5 value is the −x value, at least one processor may obtain a distortion compensation coordinate by substituting an adjacent value instead of the −x value to the x5 value.

FIG. 6C is a diagram illustrating an example of a distortion-compensated screen performed based on a projection side where an angle formed by a first housing and a second housing is the same according to various embodiments.

Referring to FIG. 6C, the display area change diagram 690 may illustrate the first display area before the distortion compensation and the second display area after the distortion compensation. The first display area may be a display area of the foldable electronic device before the distortion compensation. The second display area may be a display area of the foldable electronic device after the distortion compensation. Coordinates (a coordinate 691, a coordinate 692, a coordinate 693, and a coordinate 694) of vertices of the first display area and coordinates of an end of a folding axis 699 may be included in first coordinate information of the first display area before the distortion compensation. In the intermediate state, vertices of the display area may be changed from the coordinates (the coordinate 691, the coordinate 692, the coordinate 693, and the coordinate 694) of the vertices of the first display area to coordinates (a coordinate 695, a coordinate 696, a coordinate 697, and a coordinate 698) of vertices of the second display area, based on the first distortion compensation method. The coordinates (the coordinate 695, the coordinate 696, the coordinate 697, and the coordinate 698) of the vertices of the second display area and the coordinates of the end of the folding axis 699 may be included in second coordinate information of the second display area after the distortion compensation.

Since a position of the user's gaze may not be on the central axis, the second display area may not be bilaterally symmetrical.

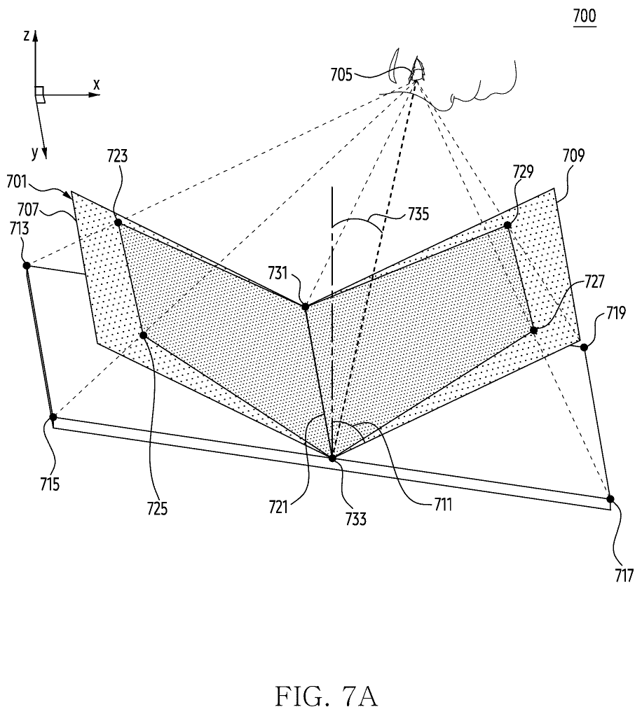

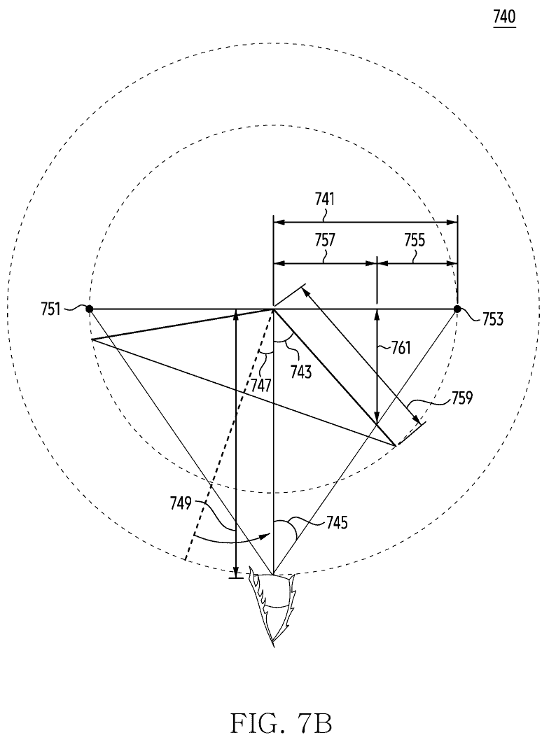

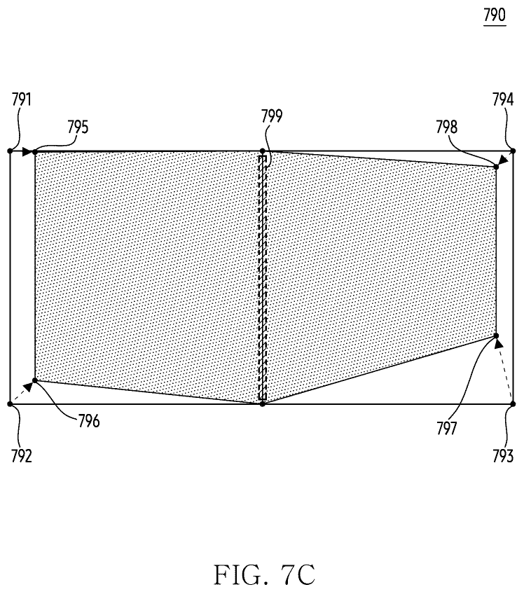

FIG. 7A is a diagram illustrating an example of distortion compensation of an electronic device based on a projection side perpendicular to a user's gaze according to various embodiments. An electronic device (e.g., the electronic device 101) may perform distortion compensation of a display (e.g., the display module 160) in a state (e.g., an intermediate state) of the electronic device. In FIG. 7A, the user's gaze may not be on a central axis, but face an arbitrary position. Hereinafter, the display may be a flexible display. A distortion compensation method performed based on the user's gaze of the arbitrary position may be referred to as a third distortion compensation method 700.

Referring to FIG. 7A, a foldable electronic device 701 (e.g., the electronic device 101 of FIG. 1) may perform the third distortion compensation method 700. A principle of the distortion compensation performed based on the projection side perpendicular to the user's gaze will be illustrated through the third distortion compensation method 700.

The foldable electronic device 701 (e.g., the foldable electronic device 431 of FIG. 4) in the intermediate state (e.g., the intermediate state 440 of FIG. 4) may be folded, so that a first side of a first housing 707 and a third side of a second housing 709 form an angle between an angle (e.g., 180 degrees) in an unfolded state and an angle (e.g., 0 degree) in a folded state. A folding axis 721 may be an axis where the foldable electronic device 701 is folded. A user gaze 705 may face an arbitrary position.

The foldable electronic device 701 may display a first display area in the unfolded state. The first display area may be specified by first coordinate information. The first coordinate information may include end coordinates of the first display area. The first coordinate information may include a coordinate 713, a coordinate 715, a coordinate 717, and a coordinate 719. The first coordinate information may include end coordinates of the folding axis. The first coordinate information may include a coordinate 731 and a coordinate 733. The foldable electronic device 701 may display a second display area in the intermediate state. The second display area may be specified by the second coordinate information. The second coordinate information may include end coordinates of the second display area. The second coordinate information may include a coordinate 723, a coordinate 725, a coordinate 727, and a coordinate 729. The second coordinate information may include the end coordinates of the folding axis. The second coordinate information may include the coordinate 731 and the coordinate 733. The first coordinate information and the second coordinate information may share coordinates (e.g., the coordinate 731 and the coordinate 733) of the folding axis.

The projection side may be perpendicular to the user's gaze. In the unfolded state of the electronic device, the projection side may be outspread to be perpendicular to the user's gaze. An angle a 711 may be half of an angle formed by the first housing and the second housing. An angle c 735 may be an angle value between a side that is perpendicular to the projection side in which the angle formed by the first housing and the second housing is the same and includes the folding axis, and a side in which the folding axis and the user's gaze are included.

In order to compensate visual distortion caused by perspective from the user's gaze 705, an image may be displayed on the second display area inside the second coordinate information. The user's gaze 705 may be a point corresponding to the user's pupils observing the display. According to an embodiment, the user's gaze 705 may be a point corresponding to the pupil of a side mainly used by the user. For example, the user's gaze 705 may indicate a point corresponding to a pupil of the left eye. For another example, the user's gaze 705 may indicate a point corresponding to a pupil of the right eye. According to an embodiment, the user's gaze 705 may be a point corresponding to a pupil of a side designated by the user. According to an embodiment, the user's gaze 705 may be a point corresponding to a pupil of a side close to the display. Since a degree of change in the display area for the distortion compensation increases when receding from the display, many margin parts may occur. According to an embodiment, the user's gaze 705 may be a point corresponding to between both pupils (e.g., center) of the user.

According to an embodiment, a processor 120 of the electronic device 101 may obtain the second coordinate information, based on the user's gaze 705 and the first coordinate information of the first display area. The user's gaze 705 may face a vertex of the first display area. A coordinate of a point where a line connecting the user's gaze 705 and a vertex of the first display area meets the flexible display of the foldable electronic device 701 may be determined as a coordinate of the second display area. For example, the foldable electronic device 701 may identify the coordinate 723 of a point where a line connecting the user's gaze 705 and the coordinate 713 meets the first side. The foldable electronic device 701 may identify the coordinate 725 of a point where a line connecting the user's gaze 705 and the coordinate 715 meets the first side. The foldable electronic device 701 may identify the coordinate 727 of a point where a line connecting the user's gaze 705 and the coordinate 717 meets the third side. The foldable electronic device 701 may identify the coordinate 729 of a point where a line connecting the user's gaze 705 and the coordinate 719 meets the third side.

The second coordinate information may be coordinate information of points where a line connecting the vertices (the coordinate 713, the coordinate 715, the coordinate 717, and the coordinate 719) of the first display area of the foldable electronic device 701 in the unfolded state and the user's gaze 705 meets the first side and the third side of the foldable electronic device 701 in the intermediate state.

User gaze information may include a coordinate of the user's gaze 705. According to an embodiment, the user gaze information may be obtained through a camera and a distance detection sensor. The user gaze information may identify a position (e.g., x-axis and y-axis coordinates) of the user's gaze through the camera, and identify a distance (e.g., z-axis coordinate) to the user's gaze through the distance detection sensor. The distance detection sensor may be a time of flight (TOF). The distance detection sensor may be light detection and ranging (Lidar).

FIG. 7B is a diagram illustrating an example 740 of x-axis distortion compensation performed based on a projection side perpendicular to a user's gaze according to various embodiments. It may be that the user is viewing the second distortion compensation method 700 from a y-axis direction.

Referring to FIG. 7B, a first value 741 (e.g., x) may correspond to a length from the folding axis to ends 751 and 753 of the first display area. The first value 741 may be a given value. A second value 743 (e.g., a−c or a+c) may correspond to a first angle formed by the second housing and a side that is perpendicular to a projection side in which an angle formed by the first housing and the second housing is the same and includes the folding axis. The second value 743 may be obtained based on a folding detection sensor, at least one camera, and at least one distance detection sensor. A third value 745 (e.g., b) may correspond to an angle formed by a direction viewing the end 753 of the first display area within the second housing in the unfolded state from the user's gaze and a side that is perpendicular to the projection side in which an angle formed by the first housing and the second housing is the same and includes the folding axis. The third value 745 may be obtained based on the first value, a fifth value, and the angle c. A fourth value 749 (e.g., z) may refer a vertical distance between the user's gaze and the display in the unfolded state. The fourth value 749 may be obtained through the camera and the distance detection sensor.

The foldable electronic device may obtain second coordinate information of the second display area of the second housing by changing the second value in the first distortion compensation method 500. A coordinate after distortion compensation of the first housing may the same as a coordinate after distortion compensation in case that the second value is the sum of the a value and the c value and the user's gaze faces the central axis. Accordingly, the second coordinate information of the second display area of the first housing may be obtained by changing the second value in the first distortion compensation method 500.

Hereinafter, an x-axis coordinate of the distortion-compensated second display area in the second housing will be calculated. A x1 value 755 may be a distance between a point where an end point of the second display area within the first housing in the intermediate state is projected and an end of the first display area in the unfolded state. A x2 value 757 may be a distance between a point where an end point of the second display area within the second housing in the intermediate state is projected and a point where the folding axis of the foldable electronic device is projected. A x3 value 759 may be a distance between the folding axis of the foldable electronic device and the end of the second display area within the second housing in the intermediate state. A x4 value 761 may be a vertical distance between the end point of the second display area within the second housing in the intermediate state and a projection side. By the trigonometric function, the following equations may be derived.

$$\frac{x 4}{x 1} = tan ( 90 - b ) \qquad [ Equation 1 ]$$

$$\frac{x 4}{x 2} = tan ( 90 - ( a - c ) ) \qquad [ Equation 2 ]$$

$$x 1 tan ( 90 - b ) = x 2 tan ( 90 - ( a - c ) ) \qquad [ Equation 3 ]$$

$$x = x 1 + x 2 \qquad [ Equation 4 ]$$

$$b = {tan}^{- 1} ( \frac{x}{z} ) \qquad [ Equation 5 ]$$

$$x 3 = \frac{x 2}{cos ( 90 - ( a - c ) )} \qquad [ Equation 6 ]$$

The x1 value 755, the x2 value 757, the x3 value 759, the x4 value 761, the b value 745, and the c value 747 may be obtained by solving the equations together as a system of the equations. The x3 value 759 may be a distance between the end of the second display area of the second housing and the folding axis of the foldable electronic device in the intermediate state. In other words, the x3 value 759 may be the x-axis coordinate of the second display area of the second housing in the intermediate state. The x3 value may be derived as in Equation 7. The x4 value may be derived as in Equation 8.

$$x 3 = \frac{x}{\{ 1 + \frac{tan ( 90 - ( a - c ) )}{tan ( 90 - b )} \} * cos ( 90 - ( a - c ) )} \qquad [ Equation 7 ]$$

$$x 4 = \frac{x * tan ( 90 - ( a - c ) )}{\{ 1 + \frac{tan ( 90 - ( a - c ) )}{tan ( 90 - b )} \}} \qquad [ Equation 8 ]$$

When the folding axis is the y-axis, an x-axis distortion compensation coordinate may be the x3 value. The x4 value may be used when calculating a y-axis distortion compensation coordinate.

The y-axis coordinates of the distortion-compensated second display area in the first housing and the second housing may be derived in the same manner as the y-axis distortion compensation method (e.g., FIG. 5C) performed based on the user's gaze facing the folding axis.

FIG. 7C is a diagram illustrating an example of a distortion-compensated screen performed based on a projection side perpendicular to a user's gaze according to various embodiments.

Referring to FIG. 7C, a display area change diagram 790 may illustrate the first display area and the second display area before and after the distortion compensation. The first display area may be a display area of the foldable electronic device before the distortion compensation. The second display area may be a display area of the foldable electronic device after the distortion compensation. Coordinates (a coordinate 791, a coordinate 792, a coordinate 793, and a coordinate 794) of vertices of the first display area and coordinates of an end of a folding axis 799 may be included in first coordinate information of the first display area before the distortion compensation. In the intermediate state, the coordinates (the coordinate 791, the coordinate 792, the coordinate 793, and the coordinate 794) of the vertices of the first display area may be changed to coordinates (a coordinate 795, a coordinate 796, a coordinate 797, and a coordinate 798) of vertices of the second display area based on the first distortion compensation method. The coordinates (the coordinate 795, the coordinate 796, the coordinate 797, and the coordinate 798) of the vertices of the second display area and coordinates of the end of the folding axis 799 may be included in second coordinate information of the second display area after the distortion compensation.

Since a position of the user's gaze does not on the central axis, the second display area may not be bilaterally symmetrical.

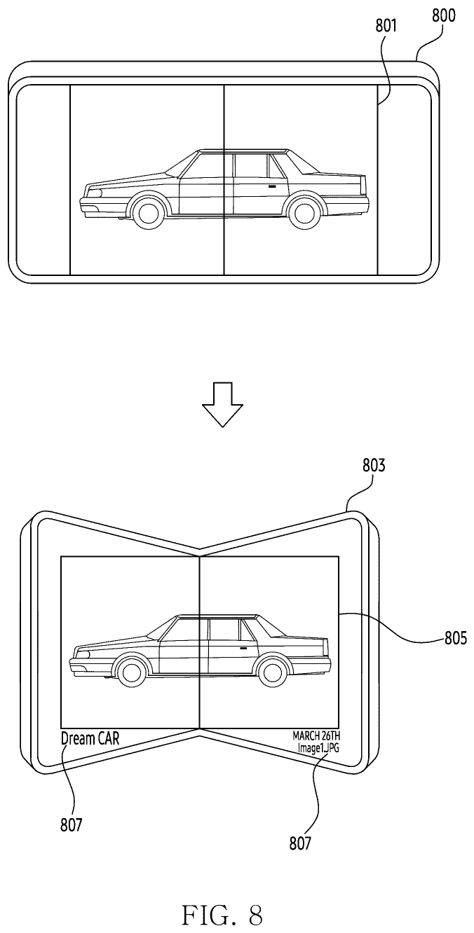

FIG. 8 is a diagram illustrating an example of using a margin by distortion compensation for displaying information according to various embodiments.

Referring to FIG. 8, a foldable electronic device 800 in an unfolded state may display an image 801 (e.g., a first image) before distortion compensation. A foldable electronic device 803 in an intermediate state may include an image 805 (e.g., a second image) after the distortion compensation. A margin part 807 of a display may be generated by the distortion compensation. The margin part 807 of the display may refer a part of the display that is within a first display area and the outside of the second display area at the same time. According to various embodiments, text, an image, or a user interface (UI) for displaying information on the image 805 after the distortion compensation may be displayed on the margin part 807. According to various embodiments, text for displaying the information on the image 805 after the distortion compensation may be displayed on the margin part 807. For example, the text may display photographing time and capacity of the image 805 after the distortion compensation. According to various embodiments, an image for displaying the information on the image 805 after the distortion compensation may be displayed on the margin part 807. For example, the image may represent a type of the image 805 after the distortion compensation. According to various embodiments, a user interface (UI) for displaying the information on the image 805 after the distortion compensation may be displayed on the margin part 807. For example, the user interface (UI) may be a button for searching the Internet for the image 805 after the distortion compensation.

In FIG. 8, the text, the image, or the user interface (UI) may be displayed only for displaying the information on the image after the distortion compensation on the margin part 807, but an embodiment of the present disclosure is not limited thereto. According to an embodiment, the text, the image, or the user interface (UI) for displaying the information on the image 805 after the distortion compensation may be displayed on the margin part 807. For example, in case that the image 805 after the distortion compensation is a sky picture, information on the weather of a shooting date may be displayed. According to an embodiment, text, an image, or a user interface (UI) for displaying information not related to the image 805 after the distortion compensation may be displayed on the margin part 807. For example, text, an image, or a user interface (UI) for displaying remaining capacity of a battery may be displayed on the margin part 807.

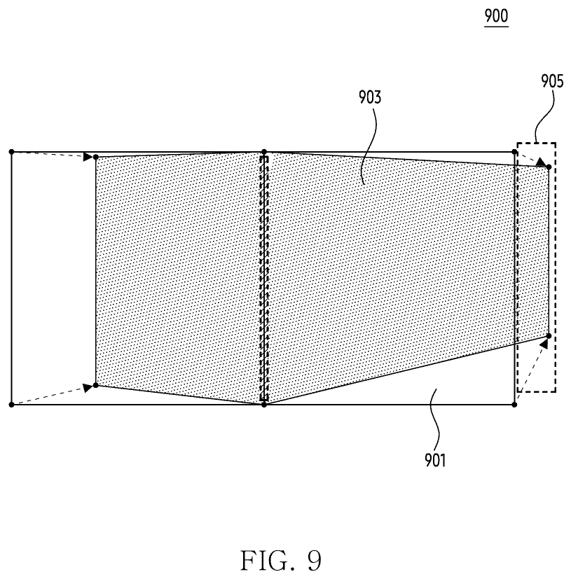

FIG. 9 is a diagram 900 illustrating an example of image loss capable of occurring during distortion compensation according to various embodiments.

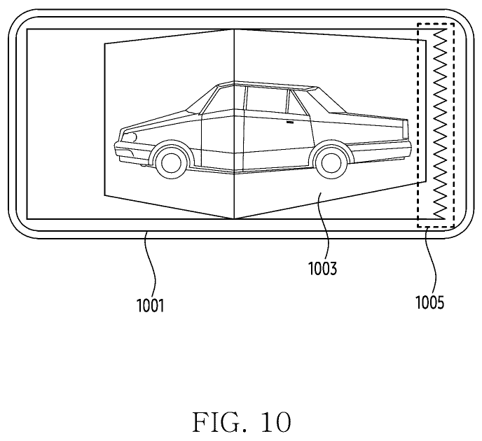

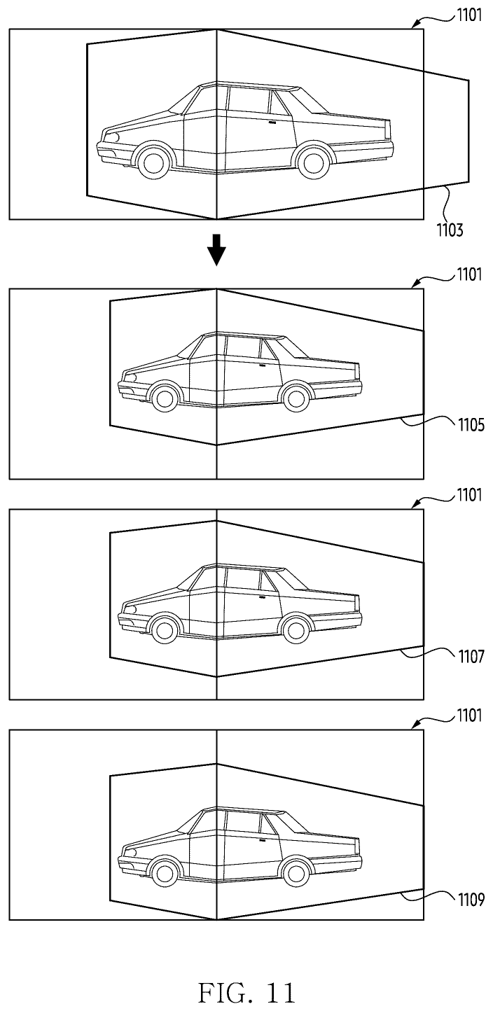

Referring to FIG. 9, a first display area 901 may be a display area before distortion compensation of a foldable electronic device in an unfolded state. A virtual display area 903 may be an area inside a line where a side connecting from a user's gaze to an end of the first display area meets a side of a first housing or a side of a second housing. An image loss part 905 may occur in case that a length from a folding axis to an end of the virtual display area is greater than a length from the folding axis to the end of the first display area. Hereinafter, in reference to FIGS. 10 and 11, in case that the image loss part 905 occurs, how to process the image loss part 905 will be described.

FIG. 10 is a diagram illustrating an example of a notification for indicating image loss during distortion compensation according to various embodiments.

Referring to FIG. 10, a foldable electronic device 1001 may display a distortion-compensated image 1003 in an intermediate state on a display. A notification 1005 may indicate image loss.

In the foldable electronic device 1001 in the intermediate state, a length from a folding axis to an end of a virtual display area may be greater than a length from the folding axis to an end of a first display area. Therefore, an image loss part (e.g., the image loss part 905 of FIG. 9) may occur. According to various embodiments, the foldable electronic device 1001 (e.g., the electronic device 101 of FIG. 1) may display the notification 1005 for indicating image loss on the display of the foldable electronic device 1001 closest to the image loss part 905. For example, the notification 1005 for indicating image loss may be displayed by marking color. For example, the notification 1005 for indicating image loss may be displayed by repeatedly blinking the color displayed on the display of the foldable electronic device 1001 closest to the image loss part 905. For example, the notification 1005 for indicating image loss may be displayed through a notification window displayed on the display of the foldable electronic device 1001 closest to the image loss part 905.

FIG. 11 is a diagram illustrating an example of image reduction during distortion compensation according to various embodiments. In case that a virtual display area is wider than an area of a display included a foldable electronic device in an intermediate state, the foldable electronic device may obtain a second display area by reducing the virtual display area, in order to display an entire image on the display.

Referring to FIG. 11, a foldable electronic device 1101 may display an image distortion-compensated in the intermediate state on the display. A first display area may be a part of a display area before distortion compensation of the display. A virtual display area 1103 may be an area where a side connecting from a user's gaze to an end of the first display area meets a side including a first housing or a side including a second housing. Second display areas 1105, 1107, and 1109 may be parts of a display area after the distortion compensation of the display. The second display areas 1105, 1107, and 1109 may be parts obtained based on the virtual display area.

According to an embodiment, in case that a length from a folding axis to an end of the virtual display area 1103 is greater than a length from the folding axis of the foldable electronic device 1101 to an end of the display area, the at least one processor may reduce an entire image, in order to display on the display. The at least one processor may reduce the length from the end of the virtual display area 1103 to the folding axis to be the length from the folding axis of the foldable electronic device to the end of the display area. The at least one processor may obtain the second display areas 1105, 1107, and 1109 by reducing the virtual display area 1103 by the same ratio with respect to an x-axis and a y-axis. When the at least one processor obtains the second display area in which the virtual display area 1103 is reduced, a part other than the second display area may occur on the folding axis. According to an embodiment, the second display area may be changed according to a disposition position of the part other than the second display area on the folding axis. For example, when the part other than the second display area on the folding axis is disposed in the bottom of the folding axis, the second display area 1105 may be obtained. For example, when the part other than the second display area on the folding axis is evenly disposed in the top and the bottom of the folding axis, the second display area 1107 may be obtained. For example, when the part other than the second display area on the folding axis is disposed in the top of the folding axis, the second display area 1109 may be obtained.

According to an embodiment, a change of the second display area may be gradually performed, in order to reduce a sense of heterogeneity according to an abrupt change in size. According to an embodiment, when the second display area is changed, a notification for indicating the change in the display area may be displayed.

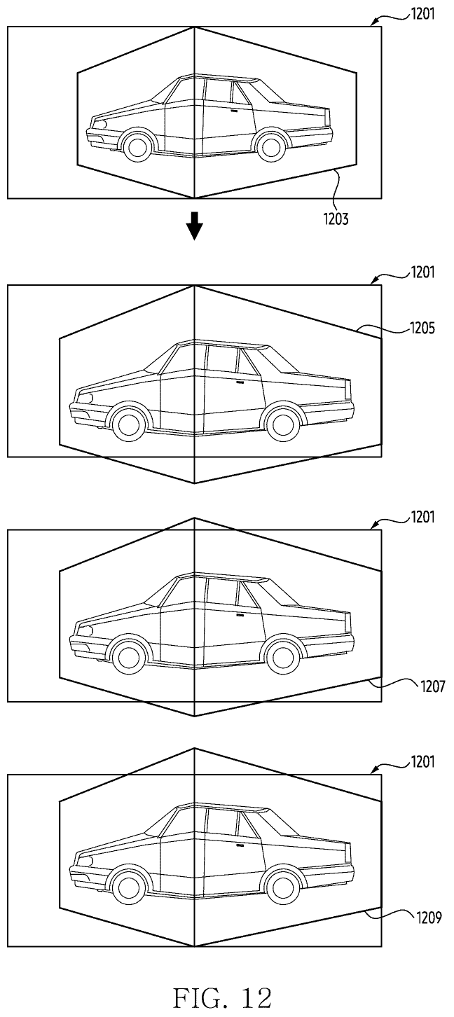

FIG. 12 is a diagram illustrating an example of image enlargement during distortion compensation according to various embodiments.

Referring to FIG. 12, a foldable electronic device 1201 in an intermediate state may display an image after the distortion compensation on a display. A first display area before the distortion compensation of the foldable electronic device 1201 may be a display area of the foldable electronic device in an unfolded state. A virtual display area 1203 may be an area where a surface connecting from a user's gaze to an end of the first display area meets a side including a first housing or a side including a second housing. Second display areas 1205, 1207, and 1209 may be parts on the display for displaying an image after the distortion compensation. The second display areas 1205, 1207, and 1209 after the distortion compensation of the electronic device may be display areas in the intermediate state. A length in a direction perpendicular to a folding axis of the second display area may be smaller than a length in a direction perpendicular to a folding axis of the first display area, by the distortion compensation.

According to an embodiment, in case that a length from the folding axis to an end of the virtual display area 1203 is shorter than a length from the folding axis of the foldable electronic device 1201 to an end of the display area, the image may be enlarged to increase usability of the display. The at least one processor may enlarge the length from the end of the virtual display area 1203 to the folding axis to be the length from the folding axis of the foldable electronic device to the end of the display area. The at least one processor may obtain the second display areas 1205, 1207, and 1209 by enlarging the virtual display area 1203 at the same ratio with respect to an x-axis and a y-axis. When the at least one processor obtains the second display area in which the virtual display area 1203 is enlarged, a margin part of the enlarged virtual display area may occur on the folding axis. The margin part of the enlarged virtual display area may not be displayed on the display. It is because the margin part of the enlarged virtual display area is out of an area of the display. According to an embodiment, the second display area may be changed according to a disposition position of the margin part of the enlarged virtual display area. For example, when the margin part of the enlarged virtual display area is disposed in the bottom of the folding axis, the second display area 1205 may be obtained. For example, when the margin part of the enlarged virtual display area is evenly disposed in the top and bottom of the folding axis, the second display area 1207 may be obtained. For example, when the margin part of the enlarged virtual display area is disposed in the top of the folding axis, the second display area 1209 may be obtained. In addition, in order to minimize and/or reduce image loss, the at least one processor may minimize and/or reduce the margin part of the enlarged virtual display area. For example, the at least one processor may obtain a second display area in which a width of the margin part is minimized and/or reduced, by identifying the width of the margin part of the enlarged virtual display area. For example, a width of the margin part lost in the second display area 1205 may be smaller than a width of the margin part lost in the second display area 1207. In addition, the width of the margin part lost in the second display area 1205 may be smaller than a width of the margin part lost in the second display area 1209. In this case, the at least one processor may display the image within the second display area 1205 in which a width of a lost margin part is minimized and/or reduced.

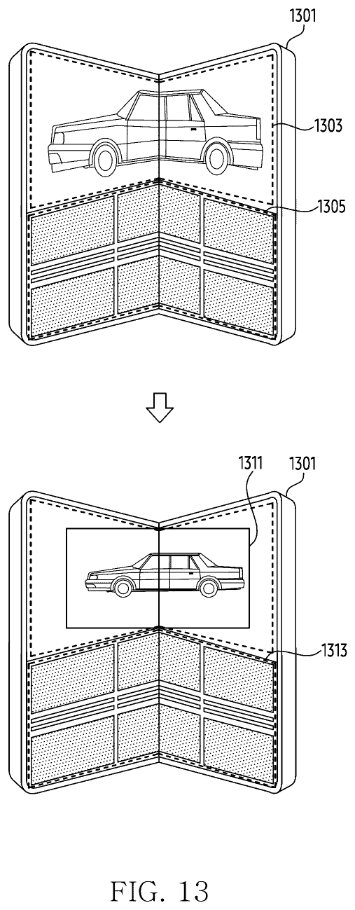

FIG. 13 is a diagram illustrating an example of distortion compensation in which only a part of a display area is applied, according to various embodiments.

Referring to FIG. 13, a foldable electronic device 1301 in an intermediate state may display an image before distortion compensation on a first display area 1303 and a third display area 1305. The foldable electronic device 1301 in the intermediate state may display an image (e.g., a second image) after the distortion compensation on a second display area 1311 where the first display area is changed. The foldable electronic device 1301 in the intermediate state may display the image before the distortion compensation on a third display area 1313 where before and after the distortion compensation are the same.

According to various embodiments, in case that a third image is displayed on the third display area of the display in an unfolded state, the third image may be displayed on the third display area of the display in the intermediate state.

According to an embodiment, the third image of the third display area 1305 may have lower visibility importance than the image of the first display area 1303. For example, when multimedia such as an image and/or a video is displayed in the first display area 1303, the at least one processor may perform distortion compensation on the image in the first display area 1303.

The at least one processor may not perform the distortion compensation on the image of the third display area 1305 where the multimedia is not displayed. When the distortion compensation is performed only on the image of the first display area by distinguishing the first display area 1303 and the third display area 1305, an efficiency of the processor may increase.

According to an embodiment, importance of touch input reception in the third image of the third display area 1305 may be higher than that of the first display area 1303. For example, when an image including content with a high touch frequency is displayed in the third display area 1305, the at least one processor may not perform the distortion compensation on the image of the third display area 1305. The at least one processor may perform the distortion compensation on the image of the first display area 1303 including content with a low touch input frequency. When the at least one processor compensates distortion of only the image of the first display area by distinguishing the first display area 1303 and the third display area 1305, the efficiency of the processor may increase.

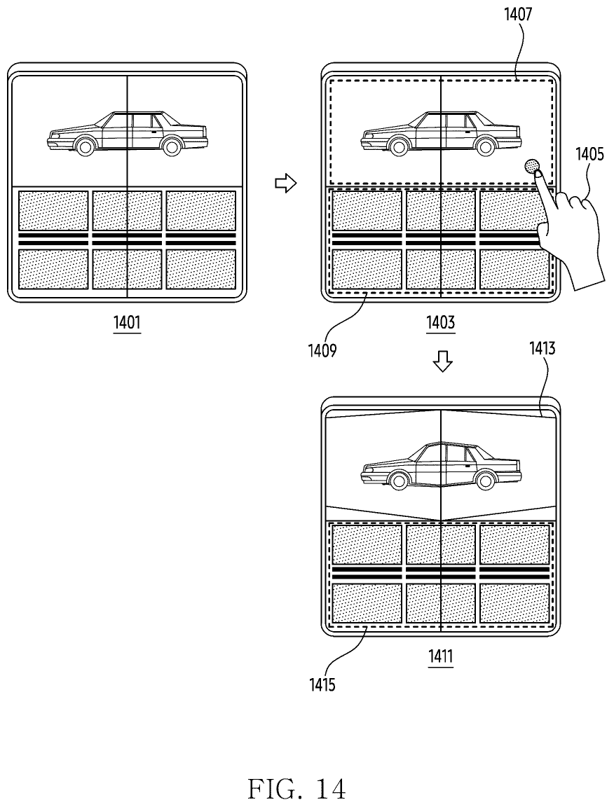

FIG. 14 is a diagram illustrating an example of selection of a display area where distortion compensation is to be applied, according to various embodiments. A user may select the display area where the distortion compensation is to be applied through a user input.

Referring to FIG. 14, in operation 1401, a foldable electronic device (e.g., the electronic device 101 of FIG. 1) may display a first image on a display in an unfolded state.

In operation 1403, the user may select (1405) a first display area 1407 to compensate distortion of an intermediate state and a third display area 1409 to not compensate the distortion of the intermediate state.

In operation 1411, a foldable electronic device 101 may change the first display area 1407 to a second display area 1413 by the distortion compensation. The foldable electronic device 101 may not perform the distortion compensation on a third display area 1415.

Although FIG. 14 illustrates a case of selecting a display area where distortion compensation is to be applied, the disclosure is not limited thereto.

According to an embodiment, the at least one processor may identify the first display area 1407 and the third display area 1409 in the intermediate state according to a designated setting. The at least one processor may perform the distortion compensation on the first display area 1407 in the intermediate state according to the designated setting.

For example, the designated setting may be set according to visibility importance. The at least one processor may identify the first display area 1407 and the third display area 1409 according to the visibility importance. When multimedia such as an image and/or a video is displayed on the first display area 1407, the at least one processor may perform the distortion compensation on the image of the first display area 1303. The at least one processor may not perform the distortion compensation on an image of the third display area 1409 where the multimedia is not displayed.

For example, the designated setting may be set according to a touch input frequency. The at least one processor may identify the first display area 1407 and the third display area 1409 according to the touch input frequency. When an image including content having a high touch frequency is displayed on the third display area 1409, the at least one processor may not perform the distortion compensation on the image of the third display area 1409. The at least one processor may perform the distortion compensation on the image of the first display area 1407 including content having a low touch input frequency.

For example, the designated setting may be set by a software application. The software application may set a standard for designating the first display area 1407 and the third display area 1409 according to the visibility importance. The software application may set the standard for designating the first display area 1407 and the third display area 1409 according to the touch input frequency.

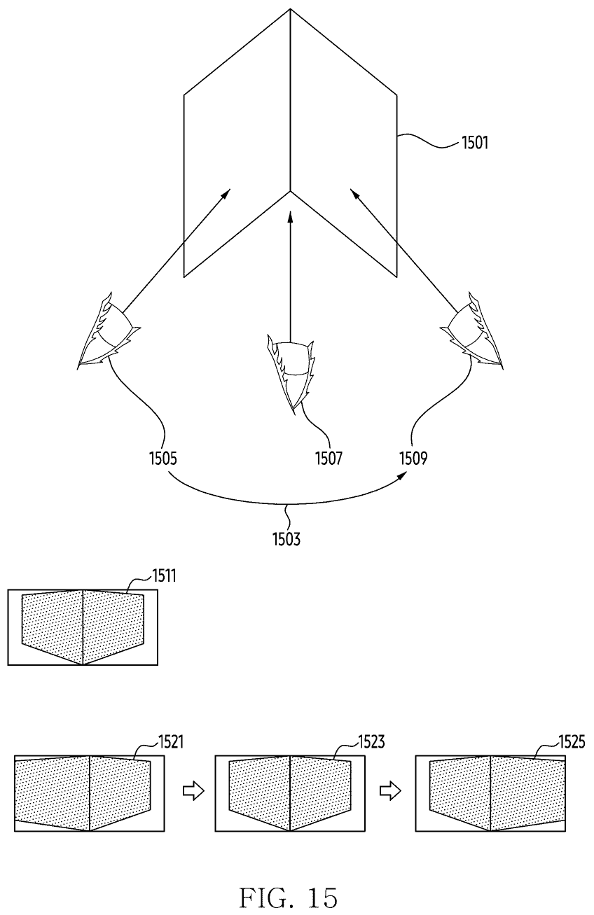

FIG. 15 is a diagram illustrating an example of whether to change distortion compensation performed based on a change of a user's gaze, according to various embodiments.

Referring to FIG. 15, a foldable electronic device 1501 may be in an intermediate state. While the foldable electronic device 1501 is in the intermediate state, a change 1503 of a user's gaze may occur. After the foldable electronic device 1501 displays a second image based on first user gaze information, the foldable electronic device 1501 may obtain second user gaze information.

According to an embodiment, the foldable electronic device 1501 may perform distortion compensation based on a designated user's gaze, such as a second display area 1511 after the distortion compensation. Regardless of the change 1503 of the user's gaze, the changed second image may be continuously displayed based on the first user gaze information.

According to an embodiment, the foldable electronic device 1501 may display the second image generated based on each user gaze information according to the change 1503 of the user's gaze. The second display area after the distortion compensation of the foldable electronic device 1501 may be changed to a second display area 1521, a second display area 1523, and a second display area 1525 according to the change 1503 of the user's gaze. According to an embodiment, the second display area 1521 may correspond to first user gaze information 1505. The second display area 1523 may correspond to second user gaze information 1507. The second display area 1525 may correspond to third user gaze information 1509.

In FIG. 15, although a case in which the user's gaze changes while the foldable electronic device 1501 is in the intermediate state is illustrated, but the disclosure is not limited thereto.

According to an embodiment, folding information may be changed in a state in which the user's gaze is maintained. The folding information may be a folding angle that is an angle formed by a first side of a first housing and a third side of a second housing of the foldable electronic device 101. The folding angle may be changed from 10 degrees to 20 degrees. For example, the at least one processor 120 may change a second display area (e.g., the second display area 1523), based on the changed folding information (e.g., changing the folding angle from 10 degrees to 20 degrees) and a fixed user's gaze.

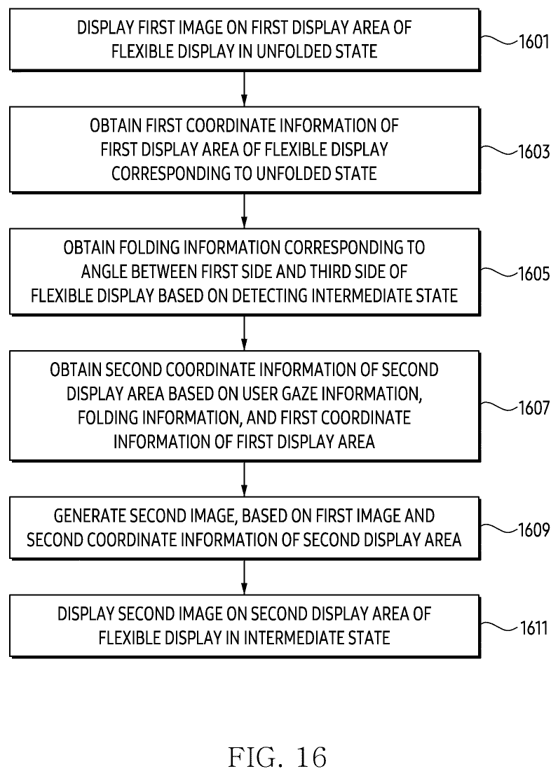

FIG. 16 is a flowchart illustrating an example operation of displaying a distortion compensation image based on user gaze information, folding information, and a first display area, according to various embodiments.

Referring to FIG. 16, in operation 1601, at least one processor (e.g., the processor 120 of FIG. 2) may display a first image on a first display area of a flexible display in an unfolded state. In operation 1603, the at least one processor 120 may obtain first coordinate information of the first display area of the flexible display corresponding to the unfolded state. In operation 1605, the at least one processor 120 may obtain folding information corresponding to an angle between a first side and a third side of the flexible display based on detecting an intermediate state. In operation 1607, the at least one processor 120 may obtain second coordinate information of a second display area based on the user gaze information, the folding information, and the first coordinate information of the first display area. In operation 1609, the at least one processor 120 may generate a second image, based on the first image and the second coordinate information of the second display area. In operation 1611, the at least one processor 120 may display the second image on the second display area of the flexible display in the intermediate state.

According to various embodiments, an electronic device including a flexible display is not based on an external camera photographing the electronic device, but is intended to compensate distortion of a screen according to a state change of the electronic device. Visual distortion according to the state change of the flexible display may be compensated using user gaze information and coordinate information without using a separate camera. Through the distortion compensation, user experience may be enhanced by compensating the visual distortion generated according to the state change of the flexible display. In addition, it is possible to efficiently use the flexible display using a margin screen generated in a visual distortion compensation process.

Although the user gaze information has been described as being obtained based on at least one camera and at least one distance detection sensor in the drawings, the disclosure is not limited thereto. For example, the user may directly input a user gaze coordinate manually.

As described above, an electronic device according to an example embodiment may comprise: a first housing including a first side and a second side opposite the first side; a second housing including a third side and a fourth side opposite to the third side; at least one processor, comprising processing circuitry; at least one camera, at least one distance detection sensor, and a flexible display; wherein by rotatably connecting the first housing and the second housing with respect to a folding axis, a hinge structure configured to provide an unfolded state in which the first side and the third side face a same direction, a folded state in which the first side and the third side face each other, and/or an intermediate state in which the first side and the third side form an angle between an angle in the unfolded state and an angle in the folded state; a folding detection sensor configured to detect an angle between the first side and the third side of the flexible display; wherein at least one processor, individually and/or collectively, may be configured to control the electronic device to: display a first image on a first display area of the flexible display in the unfolded state; obtain first coordinate information of the first display area of the flexible display corresponding to the unfolded state; based on detecting the intermediate state, obtain folding information corresponding to an angle between the first side and the third side of the flexible display; based on the at least one distance detection sensor and the at least one camera, obtain user gaze information; based on the user gaze information, the folding information, and the first coordinate information of the first display area, obtain second coordinate information of a second display area corresponding to the intermediate state; generate a second image based on the first image and the second coordinate information of the second display area; and display the second image in the second display area of the flexible display, in the intermediate state.

The first coordinate information according to an example embodiment may comprise: a first coordinate and a second coordinate with respect to the folding axis, a third coordinate and a fourth coordinate with respect to vertices of the first display area within the first housing, in the unfolded state, and a fifth coordinate and a sixth coordinate with respect to the vertices of the first display area within the second housing, in the unfolded state. The second coordinate information according to an example embodiment may comprise: a first coordinate and a second coordinate with respect to the folding axis, a seventh coordinate and an eighth coordinate with respect to vertices of the second display area within the first housing, in the intermediate state, and a ninth coordinate and a tenth coordinate with respect to the vertices of the second display area within the second housing, in the intermediate state.

The second coordinate information of the second display area according to an example embodiment may be obtained, based on a first value corresponding to a length from the folding axis to an end of the first display area. The second coordinate information of the second display area may be obtained, based on a second value corresponding to a first angle formed by the first housing and a side perpendicular to the flexible display in the unfolded state and includes the folding axis. The second coordinate information of the second display area may be obtained, based on a third value corresponding to an angle formed by a direction perpendicular to the flexible display in the unfolded state and includes the folding axis, and a direction in which a user's gaze faces an end of the first display area within the first housing in the unfolded state. The second coordinate information of the second display area may be obtained, based on a fourth value corresponding to an angle formed by a direction perpendicular to the flexible display in the unfolded state and includes the folding axis, and a direction in which the user's gaze faces an end of the first display area within the second housing in the unfolded state. The second coordinate information of the second display area may be obtained, based on a fifth value that is a vertical distance between the user's gaze and the flexible display in the unfolded state.

The second coordinate information of the second display area according to an example embodiment may be obtained, based on a sixth value corresponding to an angle formed by a direction perpendicular to the flexible display in the unfolded state and includes the folding axis, and a direction in which the user's gaze is viewed from the folding axis.

In order to obtain the second coordinate information according to an example embodiment, at least one processor, individually and/or collectively, may be configured to, based on the user gaze information, the folding information, and the first coordinate information of the first display area, obtain third coordinate information of a virtual display area, which is a change of the first display area. The virtual display area may be an area where a side connecting the user's gaze to an end of the first display area is in contact with a side including the first housing or a side including the second housing. Based on a length from the folding axis to an end of the virtual display area being greater than a length from the folding axis to the end of the first display area, at least one processor, individually and/or collectively, may be configured to obtain the second coordinate information, by changing the third coordinate information of the virtual display area to be closer to the folding axis.

In order to obtain the second coordinate information according to an example embodiment, at least one processor, individually and/or collectively, may be configured to, based on the user gaze information, the folding information, and the first coordinate information of the first display area, obtain third coordinate information of a virtual display area, which is a change of the first display area. The virtual display area may be an area where a side connecting the user's gaze to the end of the first display area is in contact with a side including the first housing or a side including the second housing. Based on the length from the folding axis to the end of the virtual display area being less than the length from the folding axis to the end of the first display area, at least one processor, individually and/or collectively, may be configured to obtain the second coordinate information, by changing the third coordinate information of the virtual display area such that the length from the folding axis to the end of the virtual display area becomes the length from the folding axis to the end of the first display area.

At least one processor according to an example embodiment may individually and/or collectively, be configured to: based on the user gaze information, the folding information, and the first coordinate information of the first display area, obtain third coordinate information of a virtual display area, which is a change in the first display area. The virtual display area may be an area where a side connecting the user's gaze to an end of the first display area is in contact with a side including the first housing or a side including the second housing. Based on a length from the folding axis to an end of the virtual display area being greater than a length from the folding axis to the end of the first display area, a notification to indicate image loss may be further displayed.

At least one processor according to an example embodiment may, individually and/or collectively, be configured to control the electronic device to: display text, an image, or a user interface (UI) for displaying information related to the second image on a portion of the flexible display within the first display area and a portion of the flexible display outside the second display area.

At least one processor according to an example embodiment may, individually and/or collectively, be configured to control the electronic device to: display a third image on a third display area of the flexible display in the unfolded state. At least one processor, individually and/or collectively, may be configured to control the electronic device to: display the third image on the third display area of the flexible display, in the intermediate state.

At least one processor according to an example embodiment may, individually and/or collectively, be configured to control the electronic device to: obtain first user gaze information, based on the at least one distance detection sensor and the at least one camera; obtain the second coordinate information of the second display area corresponding to the intermediate state, based on the first user gaze information, the folding information, and the first coordinate information of the first display area; generate the second image based on the first image and the second coordinate information of the second display area; display the second image on the second display area of the flexible display in the intermediate state; obtain second user gaze information, based on the at least one distance sensor and the at least one camera; obtain the second coordinate information of the second display area corresponding to the intermediate state, based on the first user gaze information, the folding information, and the first coordinate information of the first display area; generate the second image, based on the first image and the second coordinate information of the second display area; and display the second image on the second display area of the flexible display in the intermediate state.

As described above, a method performed by an electronic device according to an example embodiment may comprise: displaying a first image on a first display area of a flexible display in an unfolded state; obtaining first coordinate information of the first display area of the flexible display corresponding to the unfolded state; based on detecting an intermediate state, obtaining folding information corresponding to an angle between a first side and a third side of the flexible display; based on at least one distance detection sensor and at least one camera, obtaining user gaze information; based on the user gaze information, the folding information, and the first coordinate information of the first display area, obtaining second coordinate information of a second display area corresponding to the intermediate state; generating a second image based on the first image and the second coordinate information of the second display area; and displaying the second image in the second display area of the flexible display, in the intermediate state.

The first coordinate information according to an example embodiment may comprise a first coordinate and a second coordinate with respect to a folding axis. The first coordinate information may comprise a third coordinate and a fourth coordinate with respect to vertices of the first display area within a first housing, in the unfolded state. The first coordinate information may comprise a fifth coordinate and a sixth coordinate with respect to the vertices of the first display area within a second housing, in the unfolded state. The second coordinate information may comprise a first coordinate and a second coordinate with respect to the folding axis. The second coordinate information may comprise a seventh coordinate and an eighth coordinate with respect to vertices of the second display area within the first housing, in the intermediate state. The second coordinate information may comprise a ninth coordinate and a tenth coordinate with respect to the vertices of the second display area within the second housing.

The second coordinate information of the second display area according to an example embodiment may be obtained, based on a first value corresponding to a length from a folding axis to an end of the first display area. The second coordinate information of the second display area may be obtained, based on a second value corresponding to a first angle formed by a first housing and a side perpendicular to the flexible display in the unfolded state and includes the folding axis. The second coordinate information of the second display area may be obtained, based on a third value corresponding to an angle formed by a direction perpendicular to the flexible display in the unfolded state and includes the folding axis, and a direction in which a user's gaze faces an end of the first display area within the first housing in the unfolded state. The second coordinate information of the second display area may be obtained, based on a fourth value corresponding to an angle formed by a direction perpendicular to the flexible display in the unfolded state and includes the folding axis, and a direction in which the user's gaze faces an end of the first display area within a second housing in the unfolded state. The second coordinate information of the second display area may be obtained, based on a fifth value that is a vertical distance between the user's gaze and the flexible display in the unfolded state.

The second coordinate information of the second display area according to an example embodiment may be obtained, based on a sixth value corresponding to an angle formed by a direction perpendicular to the flexible display in the unfolded state and includes a folding axis, and a direction in which the user's gaze is viewed from the folding axis.

The obtaining the second coordinate information according to an example embodiment may comprise, based on the user gaze information, the folding information, and the first coordinate information of the first display area, obtaining third coordinate information of a virtual display area, which is a change of the first display area. The virtual display area may be an area where a side connecting the user's gaze to an end of the first display area is in contact with a side including the first housing or a side including the second housing. Based on a length from a folding axis to an end of the virtual display area being greater than a length from the folding axis to the end of the first display area, the obtaining the second coordinate information may comprise obtaining the second coordinate information, by changing the third coordinate information of the virtual display area to be closer to the folding axis.

The obtaining the second coordinate information according to an example embodiment may comprise, based on the user gaze information, the folding information, and the first coordinate information of the first display area, obtaining third coordinate information of a virtual display area, which is a change of the first display area. The virtual display area may be an area where a side connecting the user's gaze to an end of the first display area is in contact with a side including the first housing or a side including the second housing. Based on a length from a folding axis to an end of the virtual display area is smaller than a length from the folding axis to the end of the first display area, the obtaining the second coordinate information may comprise the obtaining the second coordinate information by changing the third coordinate information of the virtual display area, so that the length from the folding axis to the end of the virtual display area becomes the length from the folding axis to the end of the first display area.

The method according to an example embodiment may further comprise: based on the user gaze information, the folding information, and the first coordinate information of the first display area, obtaining third coordinate information of a virtual display area, which is a change of the first display area. The virtual display area may be an area where a side connecting the user's gaze to an end of the first display area is in contact with a side including the first housing or a side including the second housing. The method may further comprise, based on a length from the folding axis to an end of the virtual display area being greater than a length from the folding axis to the end of the first display area, displaying a notification to indicate image loss.

The method according to an example embodiment may further comprise displaying text, an image, or a user interface (UI) for displaying information related to the second image on a portion of the flexible display within the first display area and a portion of the flexible display outside the second display area.

The method according to an example embodiment may further comprise displaying a third image on a third display area of the flexible display in the unfolded state. The method may further comprise displaying the third image on the third display area of the flexible display, in the intermediate state.

The method according to an example embodiment may further comprise: obtaining first user gaze information, based on the at least one distance detection sensor and the at least one camera; obtaining the second coordinate information of the second display area corresponding to the intermediate state, based on the first user gaze information, the folding information, and the first coordinate information of the first display area; generating the second image based on the first image and the second coordinate information of the second display area; displaying the second image on the second display area of the flexible display in the intermediate state; obtaining second user gaze information, based on the at least one distance sensor and the at least one camera; obtaining the second coordinate information of the second display area corresponding to the intermediate state, based on the first user gaze information, the folding information, and the first coordinate information of the first display area; generating the second image, based on the first image and the second coordinate information of the second display area; and displaying the second image on the second display area of the flexible display in the intermediate state.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a first housing including a first side and a second side opposite the first side;
a second housing including a third side and a fourth side opposite to the third side;
at least one processor comprising processing circuitry;
at least one camera;
at least one distance detection sensor;
a flexible display;
a hinge structure rotatably connecting the first housing and the second housing with respect to a folding axis and configured to provide an unfolded state in which the first side and the third side face a same direction, a folded state in which the first side and the third side face each other, or an intermediate state in which the first side and the third side form an angle between an angle in the unfolded state and an angle in the folded state;
a folding detection sensor configured to detect an angle between the first side and the third side of the flexible display; and
memory storing instructions that, when executed by the at least one processor individually and/or collectively, cause the electronic device to:
display a first image on a first display area of the flexible display in the unfolded state;
obtain first coordinate information of the first display area of the flexible display corresponding to the unfolded state;
based on detecting the intermediate state, obtain folding information corresponding to an angle between the first side and the third side of the flexible display;
based on the at least one distance detection sensor and the at least one camera, obtain user gaze information;
based on the user gaze information, the folding information, and the first coordinate information of the first display area, obtain second coordinate information of a second display area corresponding to the intermediate state;
generate a second image based on the first image and the second coordinate information of the second display area; and
display the second image in the second display area of the flexible display, in the intermediate state.

2. The electronic device of claim 1,
wherein the first coordinate information comprises:
a first coordinate and a second coordinate with respect to the folding axis;
a third coordinate and a fourth coordinate with respect to vertices of the first display area within the first housing, in the unfolded state; and
a fifth coordinate and a sixth coordinate with respect to the vertices of the first display area within the second housing, in the unfolded state; and
wherein the second coordinate information comprises:
a first coordinate and a second coordinate with respect to the folding axis;
a seventh coordinate and an eighth coordinate with respect to vertices of the second display area within the first housing, in the intermediate state; and
a ninth coordinate and a tenth coordinate with respect to the vertices of the second display area within the second housing, in the intermediate state.

3. The electronic device of claim 1,
wherein the second coordinate information of the second display area is obtained, based on:
a first value corresponding to a length from the folding axis to an end of the first display area;
a second value corresponding to a first angle formed by the first housing and a side perpendicular to the flexible display in the unfolded state and includes the folding axis;
a third value corresponding to an angle formed by a direction perpendicular to the flexible display in the unfolded state and includes the folding axis, and a direction in which a user's gaze faces an end of the first display area within the first housing in the unfolded state;
a fourth value corresponding to an angle formed by a direction perpendicular to the flexible display in the unfolded state and includes the folding axis, and a direction in which the user's gaze faces an end of the first display area within the second housing in the unfolded state; and
a fifth value that is a vertical distance between the user's gaze and the flexible display in the unfolded state.

4. The electronic device of claim 3,
wherein the second coordinate information of the second display area is obtained, based on a sixth value corresponding to an angle formed by a direction perpendicular to the flexible display in the unfolded state and includes the folding axis, and a direction in which the user's gaze is viewed from the folding axis.

5. The electronic device of claim 1,
wherein in order to obtain the second coordinate information, the instructions, when executed by the at least one processor individually and/or collectively, cause the electronic device to:
based on the user gaze information, the folding information, and the first coordinate information of the first display area, obtain third coordinate information of a virtual display area, which is a change of the first display area, wherein the virtual display area is an area where a side connecting the user's gaze to an end of the first display area is in contact with a side including the first housing or a side including the second housing; and
based on a length from the folding axis to an end of the virtual display area being greater than a length from the folding axis to the end of the first display area, obtain the second coordinate information, by changing the third coordinate information of the virtual display area to be closer to the folding axis.

6. The electronic device of claim 1,
wherein in order to obtain the second coordinate information, the instructions, when executed by the at least one processor individually and/or collectively, cause the electronic device to:
based on the user gaze information, the folding information, and the first coordinate information of the first display area, obtain third coordinate information of a virtual display area, which is a change of the first display area, wherein the virtual display area is an area where a side connecting the user's gaze to the end of the first display area is in contact with a side including the first housing or a side including the second housing; and
based on the length from the folding axis to the end of the virtual display area being less than the length from the folding axis to the end of the first display area, obtain the second coordinate information, by changing the third coordinate information of the virtual display area such that the length from the folding axis to the end of the virtual display area becomes the length from the folding axis to the end of the first display area.

7. The electronic device of claim 1,
wherein the instructions, when executed by the at least one processor individually and/or collectively, cause the electronic device to:
based on the user gaze information, the folding information, and the first coordinate information of the first display area, obtain third coordinate information of a virtual display area, which is a change in the first display area, wherein the virtual display area is an area where a side connecting the user's gaze to an end of the first display area is in contact with a side including the first housing or a side including the second housing; and
based on a length from the folding axis to an end of the virtual display area being greater than a length from the folding axis to the end of the first display area, control the electronic device to display a notification to indicate image loss.

8. The electronic device of claim 1,
wherein the instructions, when executed by the at least one processor individually and/or collectively, cause the electronic device to display a text, an image, or a user interface (UI) for displaying information related to the second image on a portion of the flexible display within the first display area and a portion of the flexible display outside the second display area.

9. The electronic device of claim 1,
wherein the instructions, when executed by the at least one processor individually and/or collectively, cause the electronic device to:
display a third image on a third display area of the flexible display in the unfolded state; and
display the third image on the third display area of the flexible display, in the intermediate state.

10. The electronic device of claim 1,
wherein the instructions, when executed by the at least one processor individually and/or collectively, cause the electronic device to:
obtain first user gaze information, based on the at least one distance detection sensor and the at least one camera;
obtain the second coordinate information of the second display area corresponding to the intermediate state, based on the first user gaze information, the folding information, and the first coordinate information of the first display area;
generate the second image based on the first image and the second coordinate information of the second display area;
display the second image on the second display area of the flexible display in the intermediate state;
obtain second user gaze information, based on the at least one distance sensor and the at least one camera;
obtain the second coordinate information of the second display area corresponding to the intermediate state, based on the first user gaze information, the folding information, and the first coordinate information of the first display area;
generate the second image, based on the first image and the second coordinate information of the second display area; and
display the second image on the second display area of the flexible display in the intermediate state.

11. A method performed by an electronic device comprising:
displaying a first image on a first display area of a flexible display in an unfolded state;
obtaining first coordinate information of the first display area of the flexible display corresponding to the unfolded state;
based on detecting an intermediate state, obtaining folding information corresponding to an angle between a first side and a third side of the flexible display;
based on at least one distance detection sensor and at least one camera, obtaining user gaze information;
based on the user gaze information, the folding information, and the first coordinate information of the first display area, obtaining second coordinate information of a second display area corresponding to the intermediate state;
generating a second image based on the first image and the second coordinate information of the second display area; and
displaying the second image in the second display area of the flexible display, in the intermediate state.

12. The method of claim 11,
wherein the first coordinate information comprises:
a first coordinate and a second coordinate with respect to a folding axis;
a third coordinate and a fourth coordinate with respect to vertices of the first display area within a first housing, in the unfolded state; and
a fifth coordinate and a sixth coordinate with respect to the vertices of the first display area within a second housing, in the unfolded state; and
wherein the second coordinate information comprises:
a first coordinate and a second coordinate with respect to the folding axis;
a seventh coordinate and an eighth coordinate with respect to vertices of the second display area within the first housing, in the intermediate state; and
a ninth coordinate and a tenth coordinate with respect to the vertices of the second display area within the second housing, in the intermediate state.

13. The method of claim 11,
wherein the second coordinate information of the second display area is obtained, based on:
a first value corresponding to a length from a folding axis to an end of the first display area;
a second value corresponding to a first angle formed by a first housing and a side perpendicular to the flexible display in the unfolded state and includes the folding axis;
a third value corresponding to an angle formed by a direction perpendicular to the flexible display in the unfolded state and includes the folding axis, and a direction in which a user's gaze faces an end of the first display area within a first housing in the unfolded state;
a fourth value corresponding to an angle formed by a direction perpendicular to the flexible display in the unfolded state and includes the folding axis, and a direction in which the user's gaze faces an end of the first display area within a second housing in the unfolded state; and
a fifth value that is a vertical distance between the user's gaze and the flexible display in the unfolded state.

14. The method of claim 13,
wherein the second coordinate information of the second display area is obtained, based on a sixth value corresponding to an angle formed by a direction perpendicular to the flexible display in the unfolded state and includes a folding axis, and a direction in which the user's gaze is viewed from the folding axis.

15. The method of claim 11, wherein the obtaining the second coordinate information comprising:
based on the user gaze information, the folding information, and the first coordinate information of the first display area, obtaining third coordinate information of a virtual display area, which is a change of the first display area, wherein the virtual display area is an area where a side connecting the user's gaze to an end of the first display area is in contact with a side including the first housing or a side including the second housing; and
based on a length from a folding axis to an end of the virtual display area being greater than a length from the folding axis to the end of the first display area, obtaining the second coordinate information, by changing the third coordinate information of the virtual display area to be closer to the folding axis.

16. The method of claim 11,
wherein the obtaining the second coordinate information comprises:
based on the user gaze information, the folding information, and the first coordinate information of the first display area, obtaining third coordinate information of a virtual display area, which is a change of the first display area, wherein the virtual display area is an area where a side connecting the user's gaze to the end of the first display area is in contact with a side including the first housing or a side including the second housing; and
based on the length from the folding axis to the end of the virtual display area being less than the length from the folding axis to the end of the first display area, obtaining the second coordinate information, by changing the third coordinate information of the virtual display area such that the length from the folding axis to the end of the virtual display area becomes the length from the folding axis to the end of the first display area.

17. The method of claim 11, further comprising:
based on the user gaze information, the folding information, and the first coordinate information of the first display area, obtaining third coordinate information of a virtual display area, which is a change in the first display area, wherein the virtual display area is an area where a side connecting the user's gaze to an end of the first display area is in contact with a side including the first housing or a side including the second housing; and
based on a length from the folding axis to an end of the virtual display area being greater than a length from the folding axis to the end of the first display area, controlling the electronic device to display a notification to indicate image loss.

18. The method of claim 11, further comprising:
displaying a text, an image, or a user interface (UI) for displaying information related to the second image on a portion of the flexible display within the first display area and a portion of the flexible display outside the second display area.

19. The method of claim 11, further comprising:
displaying a third image on a third display area of the flexible display in the unfolded state; and
displaying the third image on the third display area of the flexible display, in the intermediate state.

20. A non-transitory computer-readable storage medium storing instructions, that when executed by at least one processor, cause an electronic device to perform operations including:
displaying a first image on a first display area of a flexible display in an unfolded state;
obtaining first coordinate information of the first display area of the flexible display corresponding to the unfolded state;
based on detecting an intermediate state, obtaining folding information corresponding to an angle between a first side and a third side of the flexible display;
based on at least one distance detection sensor and at least one camera, obtaining user gaze information;
based on the user gaze information, the folding information, and the first coordinate information of the first display area, obtaining second coordinate information of a second display area corresponding to the intermediate state;
generating a second image based on the first image and the second coordinate information of the second display area; and
displaying the second image in the second display area of the flexible display, in the intermediate state.
